(19) United States
(12) Patent Application Publication
(10) Pub. No.: US 2010/0219011 A1
(43) Pub. Date: Sep. 2, 2010

(54) MOVABLE APPARATUS

(76) Inventors: Sadao SHIMOYAMA, Yokohama-shi (JP); Hiroshi Kuriyama, Yokohama-shi (JP); Yasunori Chiba, Yokohama-shi (JP); Takafumi Ushiyama, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/712,638

(22) Filed: Feb. 25, 2010

(30) Foreign Application Priority Data
Feb. 27, 2009 (JP) 2009-046865
Feb. 3, 2010 (JP) 2010-022517

(51) Int. Cl. B62D 61/00; G06F 19/00

(52) U.S. Cl. 180/218; 701/124

(57) ABSTRACT

According to one embodiment, a movable apparatus includes a carriage, coaxial paired wheels configured to support the carriage, a wheel actuator configured to rotationally drive the paired wheels, a loading section provided above the carriage, a swinging section includes a first swinging mechanism configured to swing the loading section around a first shaft extending in a direction crossing an axle of the wheels and a second swinging mechanism configured to swing the loading section around a second shaft provided parallel to the axle, acceleration sensing device configured to measure accelerations, and a swing angle control device configured to control the swing angle of each of the first swinging mechanism and the second swinging mechanism, to swing the loading section in a direction in which a component force of the acceleration applied to the loading section in a horizontal direction and a component force of gravity are balanced.

### CROSS-REFERENCE TO RELATED APPLICATIONS

This application is based upon and claims the benefit of priority from prior Japanese Patent Applications No. 2009-046865, filed Feb. 27, 2009; and No. 2010-022517, filed Feb. 3, 2010, the entire contents of both of which are incorporated herein by reference.

### BACKGROUND OF THE INVENTION

1. Field of the Invention

The present invention relates to a movable apparatus that travels on a floor surface or the like while carrying a load, and in particular, to a technique for maintaining the load in a stable condition.

2. Description of the Related Art

Many movable apparatuses configured to convey loads comprise at least three wheels so as to be stabilized while stopped or traveling. The size of these movable apparatuses, comprising a large number of wheels, increases consistently with the number of wheels. A large-sized movable apparatus with a large number of wheels requires a large space for turning. Moreover, it is difficult to rapidly accelerate and decelerate such a large-sized movable apparatus, which thus has difficulty performing quick moving operations.

A movable apparatus configured to move on two wheels has been disclosed in order to solve the above-described problems (see, for example, Jpn. Pat. Appln. KOKAI Publication No. 2006-146552). The movable apparatus travels on paired driving wheels arranged on the respective opposite sides of a movable carriage. The movable apparatus comprises a gyro sensor configured to sense a swing angular velocity and a control device configured to control the operation of the movable carriage in accordance with input signals from various sensors. The movable apparatus travels with a load placed on a loading section of the apparatus.

In such a movable apparatus as described above, the gyro sensor senses the swing angular velocity of the movable apparatus in a pitching direction. Based on the sense signal, the control device controls a motor configured to drive the driving wheels. Thus, the movable apparatus carries out autonomous traveling without turning over, by allowing the paired wheels to control the swing angle in the pitching direction.

The above-described movable apparatus has the following problems. Since the loading section is fixed to the movable carrier, the swing angle of the loading section is always equal to that of the movable carriage. Thus, if during acceleration or deceleration or loading, the position of the center of gravity of the movable apparatus is displaced to tilt the movable carriage, the loading section is correspondingly tilted. When the loading section thus tilts in conjunction with the tilt of the movable carriage, the load placed on the loading section may fall down from the loading section.

### BRIEF SUMMARY OF THE INVENTION

According to one embodiment, a movable apparatus includes a carriage, coaxial paired wheels configured to support the carriage, a wheel actuator configured to rotationally drive the paired wheels by inverted pendulum control, a loading section provided above the carriage, a swinging section interposed between the carriage and the loading section and comprising a first swinging mechanism configured to swing the loading section around a first shaft extending in a direction crossing an axle of the wheels and a second swinging mechanism configured to swing the loading section around a second shaft provided parallel to the axle, acceleration sensing device configured to measure accelerations applied to the loading section in three mutually orthogonal directions, and a swing angle control device configured to control the swing angle of each of the first swinging mechanism and the second swinging mechanism based on the accelerations obtained by the acceleration sensing device, to swing the loading section in a direction in which a component force of the acceleration applied to the loading section in a horizontal direction and a component force of gravity are balanced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view showing a movable apparatus according to a first embodiment of the present invention;

FIG. 2 is a front view showing the movable apparatus according to the first embodiment;

FIG. 3 is a block diagram showing a control system in the movable apparatus according to the first embodiment;

FIG. 4 is a side view showing the movable apparatus according to the first embodiment in which a load is placed on a loading section;

FIG. 5 is a front view showing the movable apparatus according to the first embodiment in which the load is placed on the loading section;

FIG. 6 is a diagram illustrating forces acting on the load placed on the loading section according to the first embodiment;

FIG. 7 is a side view showing the movable apparatus traveling with the load placed on the loading section according to the first embodiment;

FIG. 8 is a front view showing the movable apparatus traveling with the load placed on the loading section according to the first embodiment;

FIG. 9 is a front view showing the movable apparatus traveling with the load placed on the loading section and having run on an obstacle, according to the first embodiment;

FIG. 10 is a block diagram showing a control system in a movable apparatus according to a second embodiment;

FIG. 11 is a block diagram showing inverted pendulum control in a movable apparatus according to a third embodiment of the present invention;

FIG. 12 is a block diagram showing a propulsion force calculating step in detail which is enclosed by an alternate long and two short dashes line in FIG. 11;

FIG. 13 is a block diagram showing only the translational position and translational velocity extracted from the block diagram in FIG. 11;

FIG. 14 is a side view showing a movable apparatus according to a fourth embodiment of the present invention;

FIG. 15 is a diagram showing a target trajectory of the movable apparatus according to the fourth embodiment;

FIG. 16 is a diagram illustrating a method for generating a curved trajectory of the movable apparatus according to the fourth embodiment;

FIG. 17 is a side view showing a movable apparatus according to a fifth embodiment of the present invention;

FIG. 18 is a block diagram showing a table raising and lowering mechanism according to the fifth embodiment of the present embodiment;

FIG. 19 is a side view showing a movable apparatus according to a sixth embodiment of the present invention;

FIG. 20 is a front view showing the movable apparatus according to the sixth embodiment;

FIG. 21 is an enlarged side view of a support device according to the sixth embodiment;

FIG. 22 is a side view showing the movable apparatus according to the sixth embodiment in which paired support legs are closed;

FIG. 23 is a side view showing the movable apparatus according to the sixth embodiment in which a first actuator is operating;

FIG. 24 is a block diagram of a support device according to the sixth embodiment;

FIG. 25 is a block diagram showing a control system in the movable apparatus according to the sixth embodiment;

FIG. 26 is a side view showing the stopped movable apparatus according to the sixth embodiment;

FIG. 27 is a side view schematically showing the stopped movable apparatus according to the sixth embodiment;

FIG. 28 is a side view schematically showing the inverted movable apparatus according to the sixth embodiment;

FIG. 29 is a side view schematically showing the traveling movable apparatus according to the sixth embodiment;

FIG. 30 is a side view showing a movable apparatus according to a seventh embodiment of the present invention;

FIG. 31 is a front view showing the movable apparatus according to the seventh embodiment;

FIG. 32 is an enlarged side view showing a support device in the movable apparatus according to the seventh embodiment;

FIG. 33 is a side view showing the movable apparatus according to the seventh embodiment in which paired first leg portions are closed;

FIG. 34 is a side view showing the stopped movable apparatus according to the seventh embodiment;

FIG. 35 is a side view showing the movable apparatus according to the seventh embodiment in which the first leg portions are open during traveling; and

FIG. 36 is a side view showing the emergency stop condition of the movable apparatus according to the seventh embodiment.

### DETAILED DESCRIPTION OF THE INVENTION

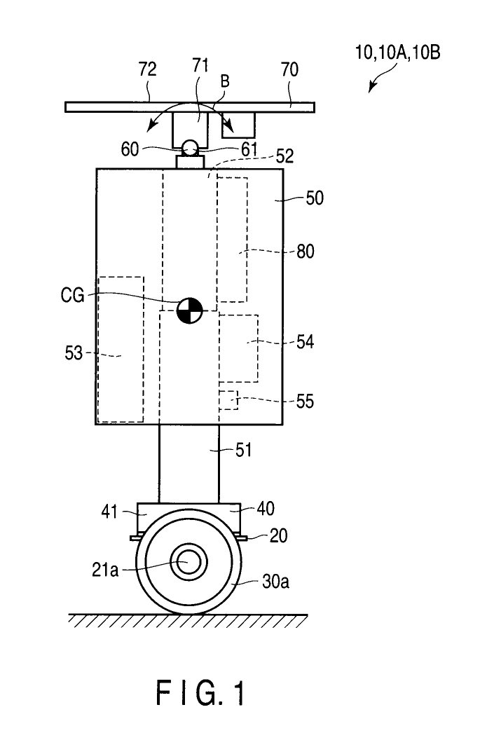

A first embodiment of the present invention will be described below with reference to FIGS. 1 to 9.

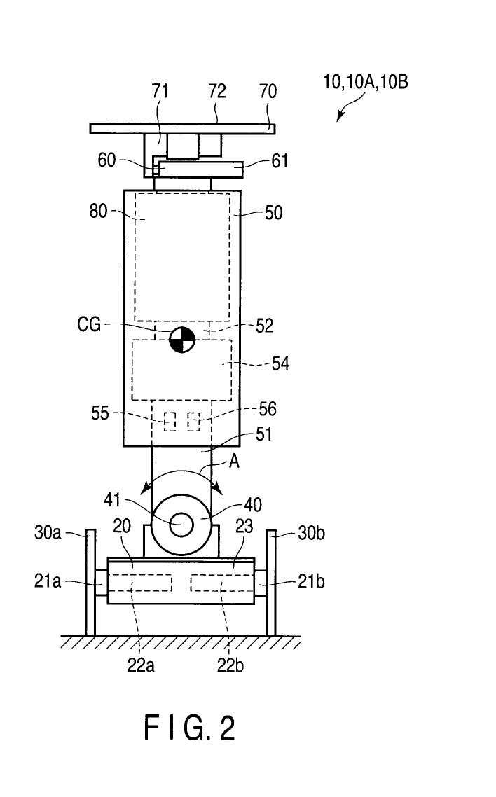

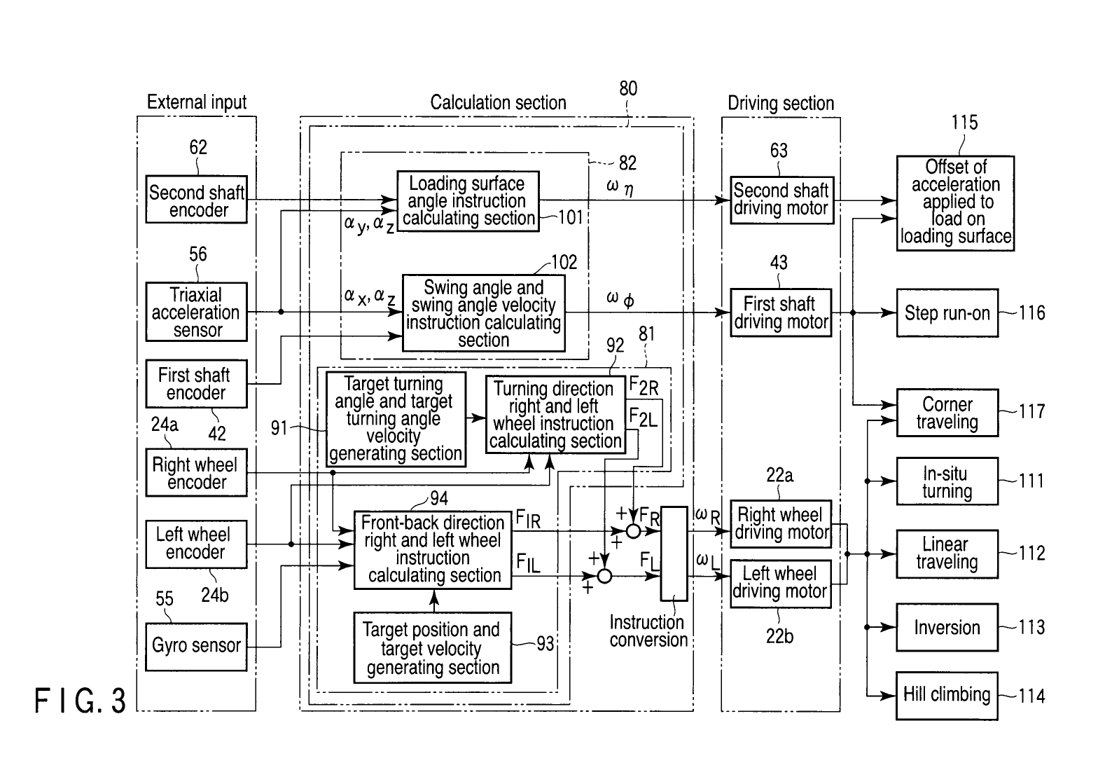

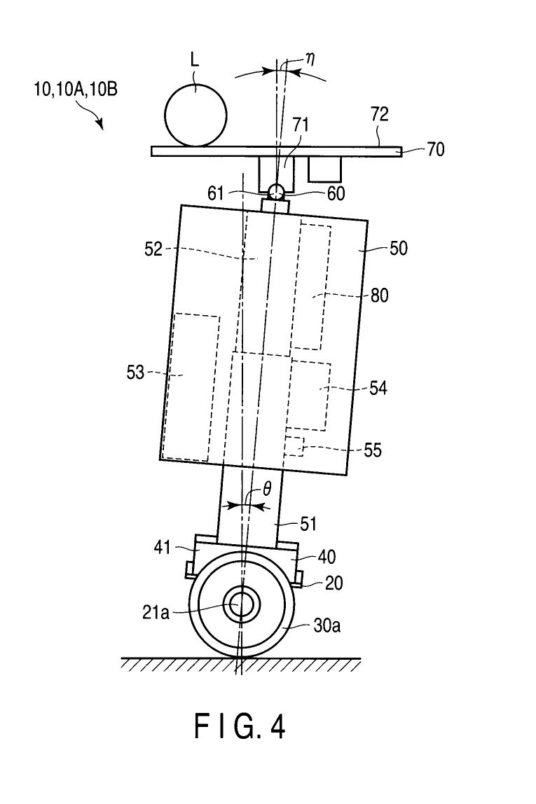

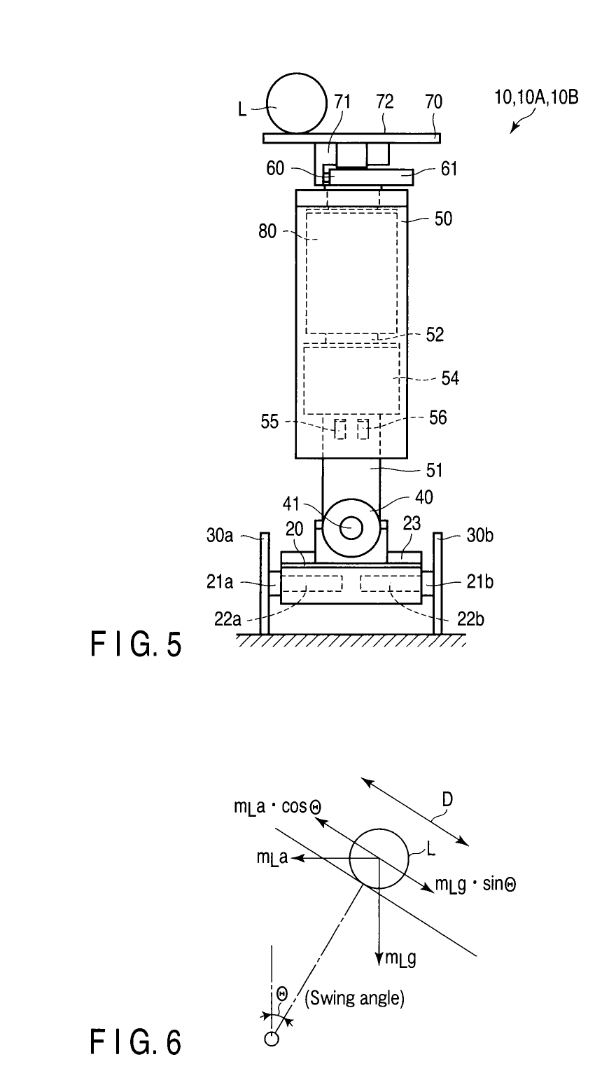

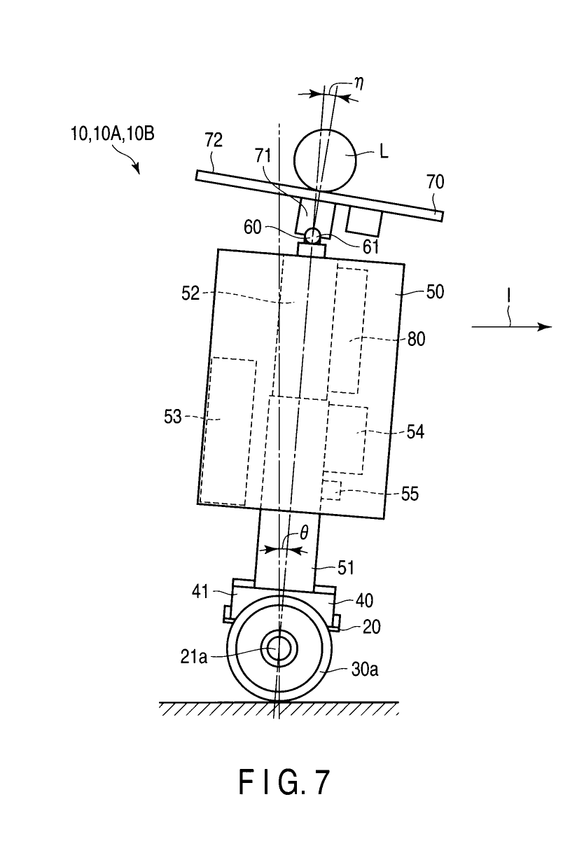

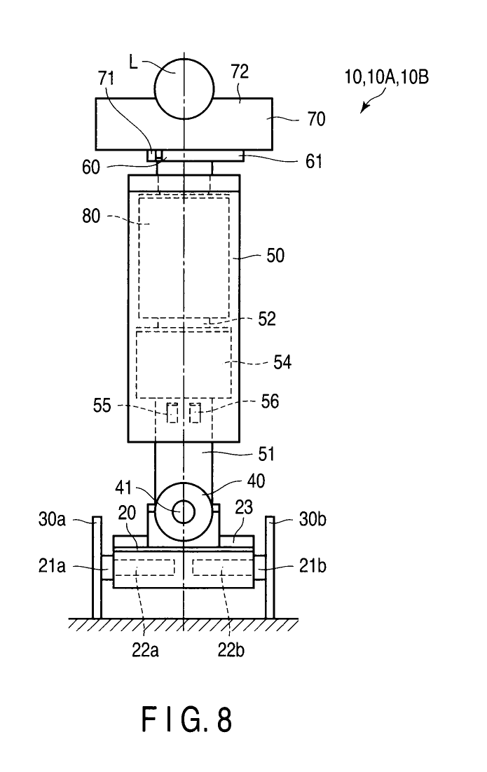

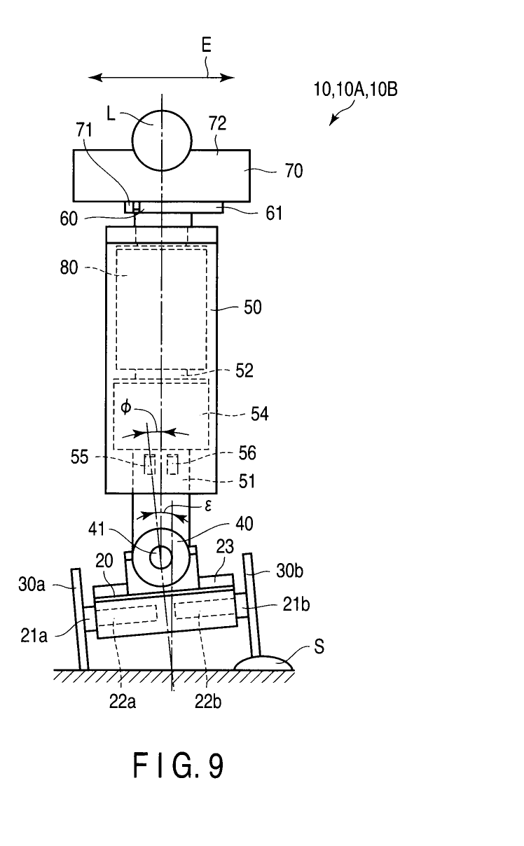

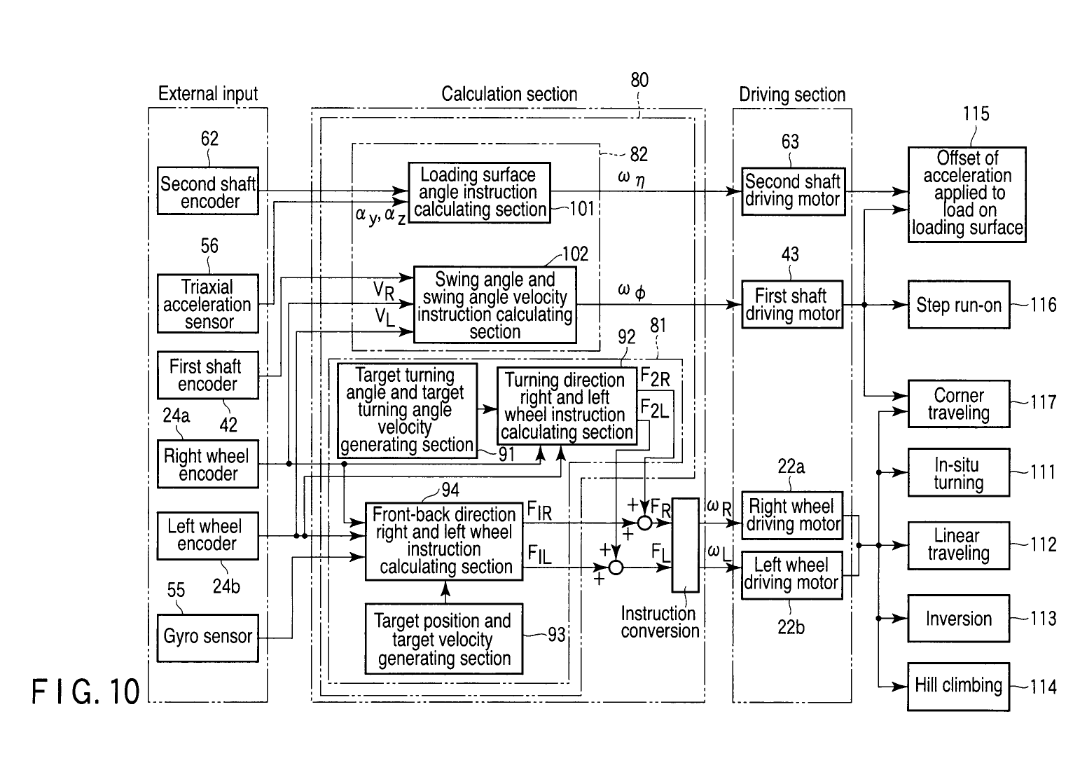

FIG. 1 is a side view showing a movable apparatus 10 according to the present embodiment. FIG. 2 is a front view showing the movable apparatus 10 in FIG. 1. FIG. 3 is a block diagram showing a control system in the movable apparatus 10. FIG. 4 is a side view showing the movable apparatus 10 in which a load L is placed on a loading section 70. FIG. 5 is a front view showing the movable apparatus 10 in FIG. 4. FIG. 6 is a diagram showing forces acting on the load L placed on the loading section 70. FIG. 7 is a side view showing the movable apparatus 10 traveling with the load L placed on the loading section 70. FIG. 8 is a front view showing the movable apparatus 10 in FIG. 7. FIG. 9 is a front view showing the movable apparatus 10 traveling with the load L placed on the loading section 70 and having run on an obstacle S.

As shown in FIGS. 1 and 2, the movable apparatus 10 comprises a carriage 20, a first swinging mechanism 40 provided on the carriage 20, a body portion 50 provided above the carriage 20 via the first swinging mechanism 40, a second swinging mechanism 60 provided above the body portion 50, a loading section 70 provided above the body portion 50 via the second swinging mechanism 60, and a control device 80 provided in the body portion 50.

The carriage 20 comprises a right axle 21a and a left axle 21b, a right-wheel driving motor (wheel actuator) 22a and a left-wheel driving motor 22b, a support section 23, and wheel encoders 24a and 24b (shown in FIG. 3). The wheel encoders 24a and 24b are illustrative of wheel rotation angle sensing devices. The right axle 21a and the left axle 21b project from the respective opposite sides of the carriage 20.

The right axle 21a and the left axle 21b are coaxially arranged and are rotatable with respect to the carriage 20. A right wheel 30a and a left wheel 30b are fixed to the ends of the right axle 21a and the left axle 21b, respectively. The support section 23 is provided in the upper part of the carriage 20 and connected to the first swinging mechanism 40.

In the description below, the side on which the right axle 21a is provided corresponds to the right direction. The side on which the left axle 21b is provided corresponds to the left direction. A direction which is orthogonal to the right axle 21a and the left axle 21b and which extends in the horizontal direction corresponds to the front-back direction. A direction that is orthogonal to the right axle 21a and the left axle 21b and which extends in the vertical direction corresponds to the up-down direction.

As shown in FIG. 2, the right-wheel driving motor 22a and the left-wheel driving motor 22b are provided inside the carriage 20 to rotationally drive the right axle 21a and the left axle 21b, respectively. The right-wheel driving motor 22a and the left-wheel driving motor 22b are individually controlled and independently driven by the control device 80. The right-wheel encoder 24a and the left-wheel encoder 24b are provided inside the carriage 20 to sense the rotation angles of the right-wheel driving motor 22a and the left-wheel driving motor 22b, respectively.

Each of the right wheel 30a and the left wheel 30b has a radius larger than the length from each of the right axle 21a and left axle 21b to the lower end of the carriage 20. The right wheel 30a and the left wheel 30b are independently rotated around the right axle 21a and the left axle 21b by the right-wheel driving motor 22a and the left-wheel driving motor 22b, respectively.

The first swinging mechanism 40 comprises a first shaft 41, a first shaft encoder 42, and a first shaft driving motor 43 (shown in FIG. 3). The first shaft 41 extends in a direction orthogonal to the right axle 21a and the left axle 21b. Specifically, the first shaft 41 extends in the front-back direction when the movable apparatus 10 is located in the vertical direction in a self-standing manner.

The first shaft encoder 42 detects the swing angle of the body portion 50 with respect to the carriage 20 in a roll direction. The first shaft encoder 42 then inputs the swing angle to the control device 80. The first shaft driving motor 43 rotationally drives the first swinging mechanism 40 around the first shaft 41.

The first swinging mechanism 40 is provided between the carriage 20 and the body portion 50. That is, the first swinging mechanism 40 is interposed between the carriage 20 and the loading section 70. In the first swinging mechanism 40, the first shaft driving motor 43 is rotationally driven based on a control signal from the control device 80 to swing the body portion 50 around the first shaft 41 with respect to the carriage 20.

The body portion 50 is supported on the carriage 20 via the first swinging mechanism 40. The body portion 50 comprises a first intermediate shaft 51 connected to the first swinging mechanism 40, a second intermediate shaft 52 connected to the second swinging mechanism 60, a battery module 53, a motor driver 54, a gyro sensor 55, a triaxial acceleration sensor (acceleration sensing means) 56, and a control device 80.

The first intermediate shaft 51 and the second intermediate shaft 52 are coaxially arranged. The first intermediate shaft 51 and the second intermediate shaft 52 extend in the up-down direction when the movable apparatus 10 is located in the vertical direction in a self-standing manner as shown in FIG. 1.

The battery module 53 is a battery configured to supply power required for the mobile apparatus 10. The motor driver 54 inputs instruction signals to the right-wheel driving motor 22a, the left-wheel driving motor 22b, the first shaft driving motor 43, and the second shaft driving motor 63 based on signals input by the control device 80. The gyro sensor 55 senses and inputs an angular velocity acting on the movable apparatus 10 to the control device 80. The triaxial acceleration sensor 56 senses and inputs accelerations acting on the movable apparatus 10 in three mutually orthogonal directions, to the control device 80.

The battery module 53, the motor driver 54, the gyro sensor 55, the triaxial acceleration sensor 56, and various other devices provided in the body portion 50 are arranged so as to be present The center of gravity CG of the movable apparatus 10 above the right axle 21a and the left axle 21b and in the body portion 50 when the movable apparatus 10 is located in the vertical direction in a self-standing manner as shown in FIG. 1.

For example, in FIG. 1, the above-described devices are arranged such that the total weight of the devices provided in the front of the apparatus is equal to the total weight of the devices provided in the back of the apparatus, with respect to the first intermediate shaft 51 and second intermediate shaft 52, located in the center of the apparatus. The center of gravity CG of the movable apparatus 10 is present in the body portion 50. Hence, the first swinging mechanism 40 is positioned below the center of gravity CG of the movable apparatus 10.

The second swinging mechanism 60 comprises a second shaft 61, a second shaft encoder 62, and a second shaft driving motor 63 (shown in FIG. 3). The second shaft 61 extends parallel to the right axle 21a and the left axle 21b. Specifically, the second shaft 61 extends in the lateral direction when the movable apparatus 10 is located in the vertical direction in a self-standing manner as shown in FIG. 1.

The second shaft encoder 62 detects and inputs the swing angle of the loading section 70 with respect to the body portion 50 in a pitch direction, to the control device 80; the swing angle is shown by arrow B in FIG. 1. The second shaft driving motor 63 rotationally drives the second swinging mechanism 60 around the second shaft 61.

The second swinging mechanism 60 is provided between the body portion 50 and the loading section 70. That is, the second swinging mechanism 60 is interposed between the carriage 20 and the loading section 70. In the second swinging mechanism 60, the second shaft driving motor 63 is rotationally driven based on a control signal from the control device 80 to swing the loading section 70 around the second shaft 61 with respect to the body portion 50.

In the present embodiment, the first swinging mechanism 40, the body portion 50, and the second swinging mechanism 60 function as an example of a swinging section.

The loading section 70 comprises a connection section 71 connected to the second swinging mechanism 60 and a flat loading surface 72 located on the connection section 71. The loading surface is desirably formed of a material with a high friction coefficient, for example, synthetic rubber. The loading surface 72 is not limited to a flat surface. For example, recesses and protrusions may be formed on the loading surface 72 in accordance with the load.

As shown in FIG. 3, the control device 80 comprises a traveling control module 81 and a posture control module (swing angle control device) 82. The traveling control module 81 performs inverted pendulum control described below to control the right-wheel driving motor 22a and the left-wheel driving motor 22b so that the movable apparatus 10 is swung and located almost in the vertical direction in a self standing manner as shown in FIG. 1. The posture control module 82 performs swing angle control described below to control the first swinging mechanism 40 and the second swinging mechanism 60 to swing the loading section 70.

As shown in FIG. 3, the traveling control module 81 comprises a turning target generating section 91, a turning instruction calculating section 92, a front-back target generating section 93, and a front-back instruction calculating section 94. The traveling control module 81 is electrically connected to the right-wheel encoder 24a, the left-wheel encoder 24b, the motor driver 54, the gyro sensor 55, the right-wheel driving motor 22a, and the left-wheel driving motor 22b.

The turning target generating section 91 generates target data on the turning angle and target turning angular velocity of the movable apparatus 10. The turning instruction calculating section 92 determines the turning angle from the rotation angular difference between the right wheel 30a and the left wheel 30b. The turning instruction calculating section 92 then calculates the turning angular velocity from the temporal differential of the turning angle. Based on a motion equation, the turning instruction calculating section 92 uses, for example, a feedback gain designed by an optimal regulator to calculate the propulsion of the right wheel 30a and the left wheel 30b so as to stabilize the system.

The front-back target generating section 93 generates targets for the position and velocity of the movable apparatus 10. The front-back instruction calculating section 94 calculates the average position of the right wheel 30a and the left wheel 30b from the average rotation angle of the right wheel 30a and the left wheel 30b. The front-back instruction calculating section 94 calculates an average velocity from the average angular velocity between the right wheel 30a and the left wheel 30b. Based on a motion equation, the front-back instruction calculating section 94 uses, for example, a feedback gain designed by the optimal regulator to calculate the propulsion of the right wheel 30a and the left wheel 30b so as to stabilize the system.

The traveling control module 81 calculates a velocity instruction based on the calculated propulsion. The traveling control module 81 then inputs the velocity instruction to the right-wheel driving motor 22a and the left-wheel driving motor 22b to control the right-wheel driving motor 22a and the left-wheel driving motor 22b.

The posture control module 82 comprises a loading angle instruction calculating section 101 and a swing angle instruction calculating section 102. The posture control module 82 is electrically connected to the first shaft encoder 42, the first shaft driving motor 43, the second shaft encoder 62, the second shaft driving motor 63, and the triaxial acceleration sensor 56.

The loading angle instruction calculating section 101 calculates a target angle for the swing angle of the second swinging mechanism 60, and temporally differentiates the target angle to obtain a target angular velocity. In order to follow the target angle and the target angular velocity, the loading angle instruction calculating section 101 calculates and converts a torque required to control the second shaft driving motor 63, into an angular velocity instruction value.

The swing angle instruction calculating section 102 calculates a target angle for the swing angle of the first swinging mechanism 40, and temporally differentiates the target angle to obtain a target angular velocity. In order to follow the target angle and the target angular velocity, the swing angle instruction calculating section 102 calculates and converts a torque required to control the first shaft driving motor 43, into an angular velocity instruction value.

Based on signals input by the first shaft encoder 42, the second shaft encoder 62, and the triaxial acceleration sensor 56, the posture control module 82 inputs instruction signals to the first shaft driving motor 43 and the second shaft driving motor 63. Based on the instruction signal, the first shaft driving motor 43 swings the body portion 50 with respect to the carriage 20. Based on the instruction signal, the second shaft driving motor 63 swings the loading section 70 with respect to the body portion 50.

Now, the above-described inverted pendulum control will be described.

The right wheel encoder 24a detects the rotation angle ξ_{R} of the right wheel. The traveling control module 81 converts the detected rotation angle ξ_{R} into a value in radian unit, and then inputs the resultant value to the turning instruction calculating section 92 and the front-back instruction calculating section 94.

The left wheel encoder 24b detects the rotation angle ξ_{L} of the left wheel. The traveling control module 81 converts the detected rotation angle ξ_{L} into a value in radian unit, and then inputs the resultant value to the turning instruction calculating section 92 and the front-back instruction calculating section 94.

The gyro sensor 55 detects the angular velocity dθ/dt of the movable apparatus 10 in the pitch direction. The traveling control module 81 converts the detected angular velocity dθ/dt into a value in radian unit, and then inputs the resultant value to the front-back instruction calculating section 94.

In (Expression 1) and (Expression 2), for example, the feedback gain Kᵢⱼ is designed by the optimal regulator so as to stabilize the inclination angle θ of the body and the average position x_{c} of the right and left wheels.

$$\begin{matrix}( m + M + \frac{{J}_{t}}{{{r}_{t}}^{2}} + \frac{{n}^{2} {J}_{m}}{{{r}_{t}}^{2}} ) \frac{{d}^{2} {x}_{c}}{d {t}^{2}} - ml \frac{d {θ}^{2}}{d t} sin θ + \{ ml cos θ - \frac{{n}^{2} {J}_{m}}{{r}_{t}} \} \frac{{d}^{2} θ}{d {t}^{2}} + {C}_{1} \frac{d {x}_{c}}{d t} = Fa & ( Expression 1 ) \\ ( ml cos θ - \frac{{n}^{2} {J}_{m}}{{r}_{t}} ) \frac{{d}^{2} {x}_{c}}{d {t}^{2}} + ( {ml}^{2} + {J}_{p} + {n}^{2} {J}_{m} ) \frac{{d}^{2} θ}{d {t}^{2}} - mg l sin θ + {C}_{2} \frac{d θ}{d t} = 0 & ( Expression 2 )\end{matrix}$$

The average position x_{c} of the right and left wheels and the average velocity dx_{c}/dt of the right and left wheels are determined by:

$$\begin{matrix}{x}_{C} = r ( {ξ}_{R} + {ξ}_{L} ) / 2 & ( Expression 3 ) \\ \frac{d {x}_{C}}{d t} = r ( \frac{d {ξ}_{R}}{d t} + \frac{d {ξ}_{L}}{d t} ) / 2 & ( Expression 4 )\end{matrix}$$

In (Expression 1) to (Expression 4), C₁ and C₂ denote viscous friction coefficients, Jₜ denotes the moment of inertia of the wheels, and (g) denotes a gravitational acceleration. Furthermore, Jₘ denotes the moment of inertia of the motor, rₜ denotes the radius of each of the right wheel 30a and the left wheel 30b, and J_{P} denotes the moment of inertia of the movable apparatus 10. Additionally, (m) denotes the mass of the movable apparatus 10, (l) denotes the distance from each of the right wheel 21a and the left wheel 21b to the center of gravity of the movable apparatus 10, (n) denotes a reduction ratio, and Fa denotes the average propulsion of the right wheel 30a and the left wheel 30b.

The front-back instruction calculating section 94 calculates a right wheel propulsion F_{1R} and the left wheel propulsion F_{1L} based on the feedback gain Kᵢⱼ, a position target x_{cr}, and a velocity target dx_{cr}/dt, as shown in:

$$[ \begin{matrix}{F}_{1 R} \\ {F}_{1 L}\end{matrix} ] = [ \begin{matrix}{K}_{11} & {K}_{12} & {K}_{13} & {K}_{14} \\ {K}_{21} & {K}_{22} & {K}_{23} & {K}_{24}\end{matrix} ] [ \begin{matrix}{x}_{cr} - {x}_{c} \\ {θ}_{r} - θ \\ \frac{d {x}_{cr}}{d t} - \frac{d {x}_{c}}{d t} \\ \frac{d {θ}_{r}}{d t} - \frac{d θ}{d t}\end{matrix} ] \qquad ( Expression 5 )$$

The front-back instruction calculating section 94 outputs the calculated right wheel propulsion F_{1R} and left wheel propulsion F_{1L}.

The turning target generating section 91 generates a turning angle target Ψᵣ and a turning angular velocity target dΨᵣ/dt for the movable apparatus 10. The turning target generating section 91 converts the turning angle target Ψᵣ and the turning angular velocity target dΨᵣ/dt into values in radian unit. The turning target generating section 91 then inputs the resultant values to the turning instruction calculating section 92.

The front-back target generating section 93 generates a position target x_{cr} and a velocity target dx_{cr}/dt for the movable apparatus 10. The front-back target generating section 93 inputs the position target x_{cr} and the velocity target dx_{cr}/dt to the front-back instruction calculating section 94.

In (Expression 6) and (Expression 7), a feedback gain K₂ᵢⱼ required to stabilize the turning angle is set by, for example, the optimal regulator.

$$\begin{matrix}( \frac{{MW}^{2}}{2} + {J}_{Ψ} ) \frac{{d}^{2} Ψ}{d {t}^{2}} = {F}_{Ψ} - {C}_{3} \frac{d Ψ}{d t} & ( Expression 6 ) \\ {F}_{Ψ} = \frac{{r}_{t}}{W} ( {F}_{2 R} - {F}_{2 L} ) & ( Expression 7 )\end{matrix}$$

In (Expression 6) and (Expression 7), dΨ/dt denotes a turning angular velocity, JΨ denotes a turning axis-wise moment of inertia, and C₃ denotes a viscous friction coefficient for turning. Furthermore, M denotes the mass of the wheels, W denotes the distance between the wheels, and rₜ denotes the radius of the wheel. Additionally, F_{2R} denotes right wheel propulsion, and F_{2L} denotes left wheel propulsion.

Based on the feedback gain K₂ᵢⱼ, the turning angle target Ψᵣ, and the turning angular velocity target dΨᵣ/dt, the turning instruction calculating section 92 calculates the right wheel propulsion F_{2R} and the left wheel propulsion F_{2L} as follows.

$$[ \begin{matrix}{F}_{2 R} \\ {F}_{2 L}\end{matrix} ] = [ \begin{matrix}{K}_{211} & {K}_{212} \\ {K}_{221} & {K}_{222}\end{matrix} ] [ \begin{matrix}{Ψ}_{r} - Ψ \\ \frac{d {Ψ}_{r}}{d t} - \frac{d Ψ}{d t}\end{matrix} ] \qquad ( Expression 8 )$$

The turning instruction calculating section 92 outputs the calculated right wheel propulsion F_{2R} and left wheel propulsion F_{2L}.

Using the propulsion F and the wheel radius rₜ, the torque τ on the wheel is expressed by:

F×rₜ=τ (Expression 9)

Furthermore, using the moment of inertia J of loads on the wheels, the average torque τ on the wheels is expressed by:

$$τ = J \frac{{d}^{2} ξ}{d {t}^{2}} \qquad ( Expression 10 )$$

ξ denotes the average rotation angle of the wheels. (Expression 9) and (Expression 10) are used to obtain:

$$\frac{{d}^{2} ξ}{d {t}^{2}} = \frac{{r}_{t}}{J} F \qquad ( Expression 11 )$$

Temporal differentiation of (Expression 11) results in the angular velocity dξ/dt. It is assumed that the moment of inertia J is equally shared by the right wheel 30a and the left wheel 30b. Then, velocity instructions ω_{Rr} and ω_{Lr} for the right wheel 30a and the left wheel 30b, respectively, are given by:

$$\begin{matrix}{ω}_{Rr} = \frac{{r}_{t}}{J / 2} \int {F}_{R} d t & ( Expression 12 ) \\ {ω}_{Lr} = \frac{{r}_{t}}{J / 2} \int {F}_{L} d t & ( Expression 13 )\end{matrix}$$

The traveling control module 81 inputs the velocity instructions ω_{Rr} and ω_{Lr} for the right wheel 30a and the left wheel 30b to the right wheel driving motor 22a and the left wheel driving motor 22b, respectively. The right-wheel driving motor 22a and the left-wheel driving motor 22b rotationally drive the right wheel 21a and the left wheel 21b based on the velocity instructions ω_{Rr} and ω_{Lr}.

The above-described inverted pendulum control enables the movable apparatus 10 to operation as shown in FIG. 3 and as described below. In-situ turning 111 can be performed by driving the right wheel 30a and the left wheel 30b in the opposite directions. In rectilinear traveling 112, the movable apparatus 10 can be moved straight ahead by driving the right wheel 30a and the left wheel 30b.

In inversion 113, the right wheel 30a and the left wheel 30b are controlled so as to prevent the movable apparatus 10 from turning over. In hill climbing 114, even on an unexpected slope, the front-back target generating section 93 and the front-back instruction calculating section 94 allows the movable apparatus to travel in a well-balanced manner so as not turn over.

Now, the above-described swing angle control will be described.

The second shaft encoder 62 detects the rotation angle (swing angle) η of the second shaft 61. The posture control module 82 converts the rotation angle η into a value in radian unit, and then inputs the resultant value to the loading angle instruction calculating section 101.

The triaxial acceleration sensor 56 detects the acceleration aₓ of the movable apparatus 10 in the lateral direction, the acceleration a_{y} of the movable apparatus 10 in the front-back direction, and the acceleration a_{z} of the movable apparatus 10 in the up-down direction. The triaxial acceleration sensor 56 inputs the accelerations a_{y} and a_{z} to the loading angle instruction calculating section 101. The triaxial acceleration sensor 56 inputs the accelerations aₓ and a_{z} to the swing angle instruction calculating section 102.

The first shaft encoder 42 detects the roll angle (swing angle) φ of the movable apparatus 10. The posture control module 82 converts the roll angle φ into a value in radian unit, and then inputs the resultant value to the swing angle instruction calculating section 102.

The swing angle instruction calculating section 102 calculates an angle target φᵣ that satisfies (Expression 14), and further temporally differentiates φᵣ to calculate an angular velocity target dφᵣ/dt.

$${φ}_{r} = {tan}^{- 1} ( \frac{{α}_{x}}{{α}_{z}} ) \qquad ( Expression 14 )$$

A feedback gain K_{φi} is calculated by the optimal regulator based on:

$$( {J}_{pb} + {J}_{m 1} {n}^{2} + {m}_{b} {l}_{b}^{2} ) \frac{{d}^{2} φ}{d {t}^{2}} + c \frac{d φ}{d t} - {m}_{b} {gl}_{b} sin φ = {τ}_{φ} \qquad ( Expression 15 )$$

In (Expression 15), (n) denotes a motor reduction ratio, J_{pb} denotes the moment of inertia of a part of the movable apparatus 10 which is provided above the first swinging mechanism 40, and Jₘ₁ denotes the moment of inertia of the first driving shaft motor 43. Furthermore, m_{b} denotes the mass of the part of the movable apparatus 10 which is provided above the first swinging mechanism 40, and (c) denotes the viscous friction coefficient. Additionally, l_{b} denotes the distance from the first shaft 41 to the center of gravity of the part of the movable apparatus 10 which is provided above the first swinging mechanism 40, and (g) denotes the gravitational acceleration.

The swing angle instruction calculating section 102 calculates a motor torque τ_{φ} by:

$$\begin{matrix}{τ}_{φ} = {K}_{φ1} ( {φ}_{r} - φ ) + {K}_{φ2} ( \frac{d {φ}_{r}}{d t} - \frac{d φ}{d t} ) & ( Expression 16 ) \\ {J}_{φ} \frac{{d}^{2} φ}{d {t}^{2}} = {τ}_{φ} & ( Expression 17 )\end{matrix}$$

Based on (Expression 16) and (Expression 17), the swing angle instruction calculating section 102 calculates an instruction velocity ω_{φ} to be provided to the first shaft driving motor 43, by:

$${ω}_{φ} = \frac{1}{{J}_{φ}} \int {τ}_{φ} d t \qquad ( Expression 18 )$$

The swing angle instruction calculating section 102 inputs the instruction velocity ω_{φ} to the first shaft driving motor 43.

The loading angle instruction calculating section 101 calculates an angle target ηᵣ that satisfies (Expression 19), and then calculates an instruction velocity ω_{η} to be provided to the second shaft driving motor 63 such that the instruction velocity ω_{η} follows the angle target ηᵣ. PID control indicated by (Expression 20) is used for feedback.

$${η}_{r} = {tan}^{- 1} ( \frac{{α}_{y}}{{α}_{z}} ) \qquad ( Expression 19 )$$

The loading angle instruction calculating section 101 calculates the deviation between the target value and the current value, that is, e(t)=pᵣ(t)−p(t). The loading angle instruction calculating section 101 uses the deviation e(t) to calculate an instruction voltage ω_{η} (t) to be output to the second shaft driving motor 63 based on (Expression 20).

$${ω}_{η} ( t ) = {K}_{C} ( e ( t ) + \frac{1}{{T}_{1}} {\int }_{0}^{t} e ( τ ) d τ + {T}_{D} \frac{d e ( t )}{d t} ) \qquad ( Expression 20 )$$

In (Expression 20), K_{C}, T_{I}, and T_{D} denote PID gain.

The loading angle instruction calculating section 101 inputs the instruction velocity ω_{η} to the second shaft driving motor 63.

Based on the input instruction velocity ω_{φ}, the first shaft driving motor 43 is rotationally driven to swing the first swinging mechanism 40. Based on the input instruction velocity ω_{η}, the second shaft driving motor 63 is rotationally driven to swing the second swinging mechanism 60.

The above-described swing angle control enables the movable apparatus 10 to operate as follows. In acceleration offset 115, the second swinging mechanism 60 is swung to balance the accelerations applied to the respective opposite sides of the load on the loading surface 72 in the front-back direction. Thus, the load L is kept stopped with respect to the loading section 70.

In step climb-over 116, the first swinging mechanism 40 is swung to keep the load L stopped relative to the loading section 70 even though the movable apparatus 10 climbs over a step formed by an obstacle or the like. In corner traveling 117, the first swinging mechanism 40 and the second swinging mechanism 60 are swung to keep the load L stopped relative to the loading section 70.

The acceleration offset 115 will be described below in detail.

As shown in FIGS. 4 and 5, when the load L is placed on the loading surface 72 of the stationary movable apparatus 10, the weight of the load L changes the position of the center of gravity CG of the movable apparatus 10 as a whole. When the position of the center of gravity CG changes, the traveling control module 81 performs inverted pendulum control to change the angle θ of the movable apparatus 10 in the pitch direction, thus moving the position of the center of gravity CG in the front-back direction. A change in the angle θ of the movable apparatus 10 causes the loading surface 72 to be tilted also by the angle θ.

The gyro sensor 55 senses the angular velocity dθ/dt of the movable apparatus 10, and the triaxial acceleration sensor 56 detects the accelerations aₓ, a_{y}, and a_{z} of the movable apparatus 10. Based on the detected angle θ and the accelerations aₓ, a_{y}, and a_{z}, the posture control module 82 swings the second swinging mechanism 60 so as to balance forces exerted on the load L in the direction of arrow D in FIG. 6. Arrow D extends in the horizontal direction with respect to the loading surface 72 and orthogonally to the second shaft 61.

In the state shown in FIGS. 4 and 5, the movable apparatus 10 maintains an almost constant posture under the control of the traveling control module 81. Thus, the movable apparatus 10 undergoes almost no lateral acceleration aₓ and almost no front-back acceleration a_{y}. The vertical acceleration a_{z} of the movable apparatus 10 corresponds to the gravitational acceleration (g). Thus, only a gravity m_{L}g shown in FIG. 6 acts on the load L. m_{L} denotes the mass of the load L.

In the direction of arrow D, a component force m_{L}g ·sin Θ of the gravity m_{L}g acts on the load L. The symbol Θ in FIG. 6 denotes the inclination angle of the loading surface 72 with respect to the vertical direction, and Θ=θ+η. The symbol η denotes the inclination angle, in the direction of arrow D, of the loading section 70 with respect to the axial direction of the movable apparatus 10.

The posture control module 82 swings the second swinging mechanism 60 such that m_{L}g ·sin Θ=0. That is, the second swinging mechanism 60 is swung such that sin Θ=0, thus making η equal to −θ as shown in FIG. 4. If η=−θ, then sin Θ=sin(0), and thus m_{L}g ·sin(0)=0. Hence, the force acting on the load L in the direction of arrow D is cancelled. This allows the load L to be kept stopped relative to the loading section 70.

As shown in FIGS. 7 and 8, when the movable apparatus 10 accelerates in the direction of arrow I, the traveling control module 81 performs the inverted pendulum control to change the angle θ of the movable apparatus 10 in the pitch direction. The change in the angle θ of the movable apparatus 10 causes the loading surface 72 to tilt by the angle θ.

The movable apparatus 10 is accelerated at the acceleration (a) in the direction of arrow I. Thus, the acceleration (a) is calculated from the accelerations a_{y} and a_{z}. That is, an inertia force m_{L}a and the gravity m_{L}g, both shown in FIG. 6, act on the load L. In the direction of arrow D, m_{L}a ·cos Θ, a component force of the inertia force m_{L}a, and m_{L}g ·sin Θ, a component force of the gravity m_{L}g, act on the load L.

The posture control module 82 swings the second swinging mechanism 60 such that m_{L}a cos Θ+m_{L}g ·sin Θ=0. That is, the posture control module 82 swings the second swinging mechanism 60 to adjust the inclination angle η such that m_{L}a ·cos(θ+η)+m_{L}g ·sin(θ+η)=0. Thus, the force acting on the load L in the direction of arrow D is cancelled. This allows the load L to be kept stopped relative to the loading section 70.

Now, the step climb-over 116 will be described.

As shown in FIG. 9, when the movable apparatus 10 being accelerated at the acceleration (a) runs on the obstacle S, the angle ε of the movable apparatus 10 in the roll direction changes. The change in the angle ε of the movable apparatus 10 causes the loading surface 72 to tilt also by the angle ε.

The triaxial acceleration sensor 56 detects the accelerations aₓ, a_{y}, and a_{z}. Based on the detected accelerations aₓ, a_{y}, and a_{z}, the posture control module 82 not only swings the second swinging mechanism 60 as described above but also swings the first swinging mechanism 40 so that the forces acting on the load L in the horizontal direction with respect to the loading surface 72 are balanced.

In the state shown in FIG. 9, the movable apparatus 10 undergoes almost no lateral acceleration aₓ. The acceleration (a) is calculated from the accelerations a_{y} and a_{z}. That is, the inertia force m_{L}a and the gravity m_{L}g act on the load L.

In the direction of arrow D, a component force of the inertia force m_{L}a and a component force of the gravity m_{L}g act on the load L. The forces acting in the direction of arrow D are balanced by the above-described swinging of the second swinging mechanism 60.

In the direction of arrow E in FIG. 9, a component force m_{L}g ·sin Φ of the gravity m_{L}g acts on the load L. Arrow E extends in the horizontal direction with respect to the loading surface 72 and parallel to the second shaft 61. The symbol Φ denotes the lateral inclination angle of the loading surface 72 with respect to the vertical direction, and Φ=ε+φ. The symbol φ denotes the inclination angle, in the direction of arrow E, of the loading section 70 with respect to the axial direction of the movable apparatus 10.

The posture control module 82 swings the first swinging mechanism 40 such that mLg ·sin Φ=0. That is, the first swinging mechanism 40 is swung such that sin Φ=0, thus making φ equal to −ε as shown in FIG. 9. If φ=−ε, then sin Φ=sin(0)=0, and thus m_{L}g ·sin(0)=0. Hence, the force acting on the load L in the direction of arrow E is cancelled. This allows the load L to be kept stopped relative to the loading section 70.

The first swinging mechanism 40 is provided below the body portion 50. Specifically, the first swinging mechanism 40 is provided at a position such that the inertia ratio of a group of the carriage 20, the right wheel 30a, and the left wheel 30b to a group of the body portion 50, the second swinging mechanism 60, and the loading section 70 is about 20:1; the first swinging mechanism 40 is provided between the former group and the latter group.

Thus, if the movable apparatus 10 turns, the body portion 50, second swinging mechanism 60, and loading section 70 provided above the first swinging mechanism 40 can be easily swung by the first swinging mechanism 40.

Furthermore, if the movable apparatus 10 travels along a rough road, for example, if the movable apparatus 10 runs on the obstacle S, then the carriage 20, right wheel 30a, and left wheel 30b provided below the first swinging mechanism 40 can be easily swung by the first swinging mechanism 40.

The corner traveling 117 will be described below in detail.

If the movable apparatus 10 travels along a curved path at a constant velocity, the centrifugal acceleration (a) acts on the movable apparatus 10. The centrifugal acceleration (a) also acts on the load L on the loading surface 72 of the movable apparatus 10.

The triaxial acceleration sensor 56 detects the accelerations aₓ, a_{y}, and a_{z} of the movable apparatus 10. Based on the detected accelerations aₓ, a_{y}, and a_{z}, the posture control module 82 swings the first swinging mechanism 40 so that the forces acting on the load L in the horizontal direction with respect to the loading surface 72 are balanced.

In the corner traveling 117, the movable apparatus 10 travels at a constant velocity and thus undergoes almost no front-back acceleration a_{y}. The acceleration (a) is calculated from the accelerations aₓ and a_{z}.

That is, a centrifugal force m_{L}a and the gravity m_{L}g act on the load L. In the direction of arrow E in FIG. 9, a component force m_{L}a ·cos Φ of the centrifugal force m_{L}a and a component force m_{L}g ·sin Φ of the gravity m_{L}g act on the load L.

The posture control module 82 swings the first swinging mechanism 40 such that m_{L}a ·cos Φ+m_{L}g ·sin Φ=0. That is, the first swinging mechanism 40 is swung to adjust the inclination angle φ such that m_{L}a ·cos(ε+φ)+m_{L}g ·sin(ε+φ)=0.

The first swinging mechanism 40 is provided below the center of gravity CG of the movable apparatus 10. When the first swinging mechanism 40 swings by the inclination angle φ, the position of the center of gravity CG also swings by the inclination angle φ. Thus, the following is positioned between the right wheel 30a and the left wheel 30b: the intersection point between the extension of the resultant vector of the gravity and the lateral force acting on the center of gravity CG and the ground surface contacted by the right wheel 30a and the left wheel 30b.

This causes the force acting on the load L in the direction of arrow E to be cancelled, and allows the movable apparatus 10 to travel stably. Hence, the load L can be kept stopped relative to the loading section 70.

As shown in FIG. 3, the movable apparatus 10 can perform operations such as the in-situ turning 111, rectilinear traveling 112, the inversion 113, the hill climbing 114, the acceleration offset 115, the step climb-over 116, and the corner traveling 117.

The number of those of the above-described operations which can be performed by the movable apparatus 10 at a time is not limited to one. The movable apparatus 10 can perform combinations each of several operations except those of contradictory operations. For example, the movable apparatus 10 can simultaneously perform the hill climbing 114 and the corner traveling 117.

As described above, when a force is exerted on the loading section 70 of the movable apparatus 10 in the horizontal direction, the first swinging mechanism 40 and the second swinging mechanism 60 swing the loading section 70 in the direction in which the force is cancelled. Thus, even if a certain force is exerted on the load L on the loading section 70, the load L can be kept stopped relative to the loading section 70.

The movable apparatus 10 swings the first swinging mechanism 40 and the second swinging mechanism 60 to cancel the force acting on load L in the horizontal direction with respect to the loading surface 72. Only the downward force acting perpendicularly to the loading surface 72 is exerted on the load L. Thus, even if the load L is a container filled with water, the movable apparatus 10 can travel while avoiding spilling the liquid.

Now, another embodiment of the present invention will be described with reference to FIGS. 10 to 36. In this case, components providing the same functions as those of the corresponding components of the movable apparatus 10 according to the first embodiment are denoted by the same reference numerals and will not be described below.

First, the second embodiment of the present invention will be described. FIG. 10 is a block diagram showing a control system in a movable apparatus 10A. In the second embodiment, the posture control module 82 is also electrically connected to the right-wheel encoder 24a and the left-wheel encoder 24b.

The swing angle instruction calculating section 102 according to the second embodiment calculates a velocity v_{R} and a velocity v_{L} from the right-wheel encoder 24a and the left-wheel encoder 24b, respectively, instead of obtaining the accelerations aₓ and a_{y} from the triaxial acceleration sensor 56. The velocity v_{R} is the velocity of the right wheel 30a. The velocity v_{L} is the velocity of the right wheel 30b.

The swing angle instruction calculating section 102 calculates an angle target φᵣ, that satisfies (Expression 21). Moreover, the swing angle instruction calculating section 102 subjects the angle target φᵣ, to temporal differentiation to calculate an angular velocity target dφᵣ/dt.

$$\begin{matrix}{φ}_{r} = {tan}^{- 1} ( \frac{v}{Rg} ) \\ = {tan}^{- 1} ( \frac{( {v}_{R} + {v}_{L} ) ( {v}_{R} - {v}_{L} )}{2 Wg} )\end{matrix} \qquad ( Expression 21 )$$

As shown in (Expression 21), the angle target φᵣ, is calculated based on the velocity v_{R} and the velocity v_{L}. The movable apparatus 10A uses the angle target φᵣ, calculated by (Expression 21) to perform swing angle control as is the case with the first embodiment.

In the movable apparatus 10A configured as described above, the right-wheel encoder 24a and the left-wheel encoder 24b can be used instead of the triaxial acceleration sensor 56 to calculate the angle target φᵣ. Thus, the movable apparatus 10A exerts the same effects as those of the movable apparatus 10 according to the first embodiment.

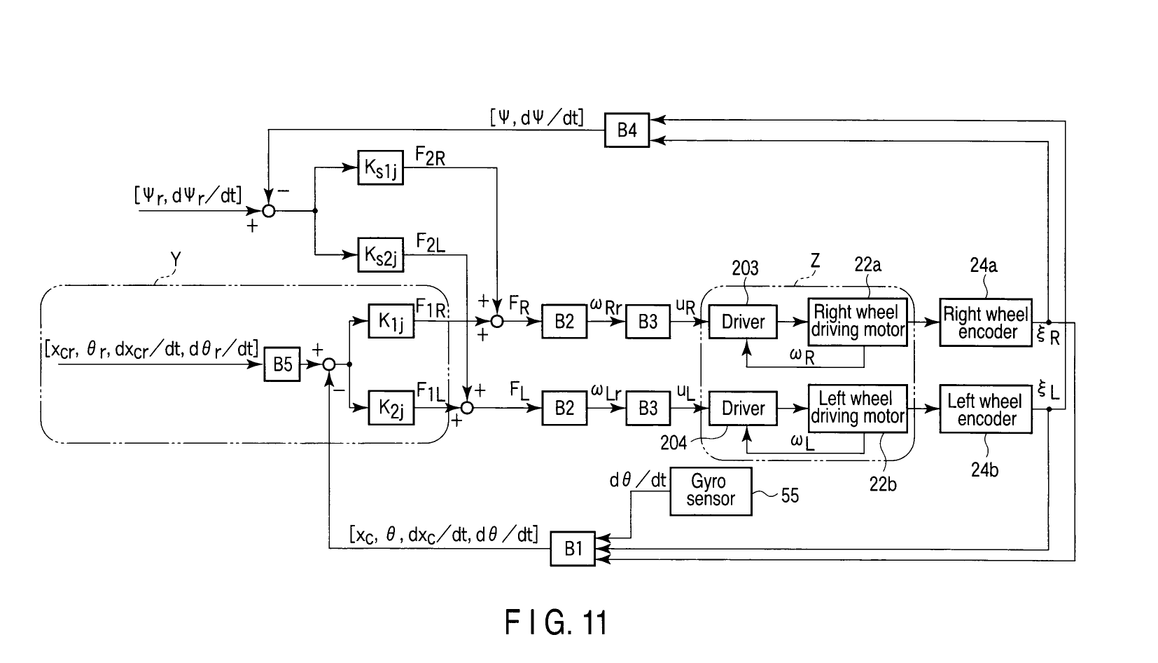

Now, a third embodiment of the present invention will be described. FIG. 11 is a block diagram showing inverted pendulum control in a movable apparatus 10B. The movable apparatus 10B according to the third embodiment is different from the first embodiment in that the movable apparatus 10B performs the control in block B5 shown in FIG. 11.

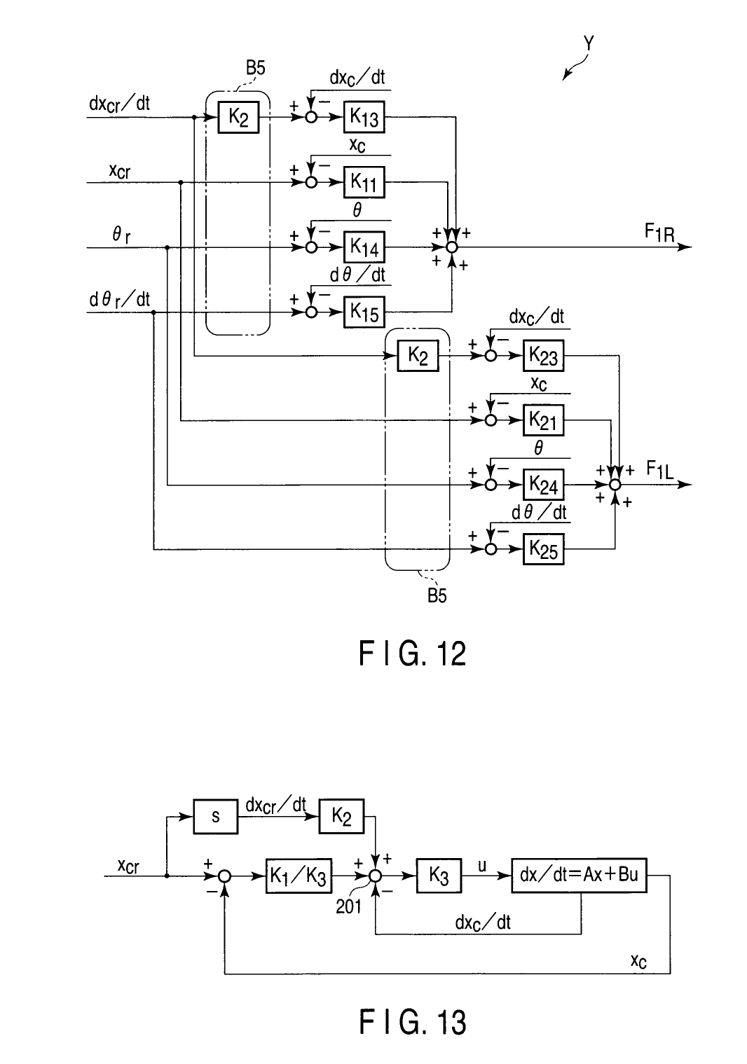

FIG. 12 is a block diagram showing a propulsion calculating step Y in detail which step is enclosed by an alternate long and two short dashes line in FIG. 11. As shown in FIG. 12, in block B5, the velocity target dx_{cr}/dt is multiplied by a gain K₂. The gain K₂ is designed based on, for example, experimental values.

FIG. 13 is a block diagram showing only a translational position and a translational velocity extracted from the block diagram in FIG. 11. As shown in FIG. 13, the velocity target dx_{cr}/dt obtained from the position target x_{cr} is added to the position target x_{cr} at an addition point 201. That is, the velocity target dx_{cr}/dt corresponds to feedforward. The velocity target dx_{cr}/dt is multiplied by the gain K₂ to obtain a feedforward instruction.

According to the movable apparatus 10B configured as described above, the velocity target dx_{cr}/dt is multiplied by the gain K₂ to obtain a feedforward instruction. This enables overshoot in velocity to be suppressed, thus inhibiting the output limit of the right-wheel driving motor 22a and the left-wheel driving motor 22b from being exceeded. Moreover, possible downshoot in velocity can be inhibited while the movable apparatus is stopped, thus preventing the movable apparatus 10B from traveling past a stop position and colliding against an obstacle located in front of the stop position.

The movable apparatus 10B according to the third embodiment is different from the first embodiment in that the movable apparatus 10B carries out a velocity feedback step Z which step is enclosed by an alternate long and two short dashes line in FIG. 11. In the velocity feedback step Z, the velocities ω_{R} and ω_{L} of the right wheel 30a and the left wheel 30b, respectively, are input to the traveling control module 81.

Based on the input velocity ω_{R} of the right wheel 30a and the velocity instruction cω_{Rr}, the traveling control module 81 calculates an optimum input voltage u_{R}. Based on the input velocity ω_{L} of the left wheel 30b and the velocity instruction ω_{Lr}, the traveling control module 81 calculates an optimum input voltage u_{L}.

The traveling control module 81 inputs the calculated input voltage u_{R} to a motor driver 203 for the right-wheel driving motor 22a. The traveling control module 81 inputs the calculated input voltage u_{L} to a motor driver 204 for the left-wheel driving motor 22b.

The movable apparatus 10B carries out the velocity feedback step of calculating the optimum input voltage based on the velocity and the velocity instruction. This allows a torque dead zone of the right-wheel driving motor 22a and the left-wheel driving motor 22b to be eliminated. Thus, a stable control system designed based on a model can be applied to the velocity control of the right wheel 30a and the left wheel 30b. As a result, the performance of the inverted pendulum control is improved.

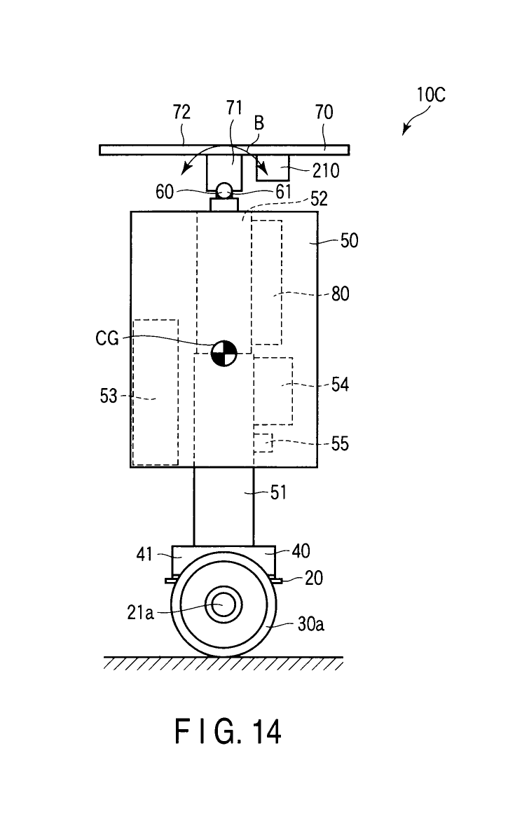

Now, a fourth embodiment of the present invention will be described. FIG. 14 is a side view showing a movable apparatus 10C according to the fourth embodiment. The movable apparatus 10C according to the fourth embodiment is different from the first embodiment in that the movable apparatus 10C comprises a laser range finder 210. The laser range finder 210 is an example of an external sensor. The laser range finder 210 is electrically connected to the traveling control module 81.

The laser range finder 210 is attached to the loading section 70. The laser range finder 210 is provided in the front of the movable apparatus 10C. The laser range finder 210 is a sensor configured to measure the distance and angle to an object positioned in front of the laser range finder 210.

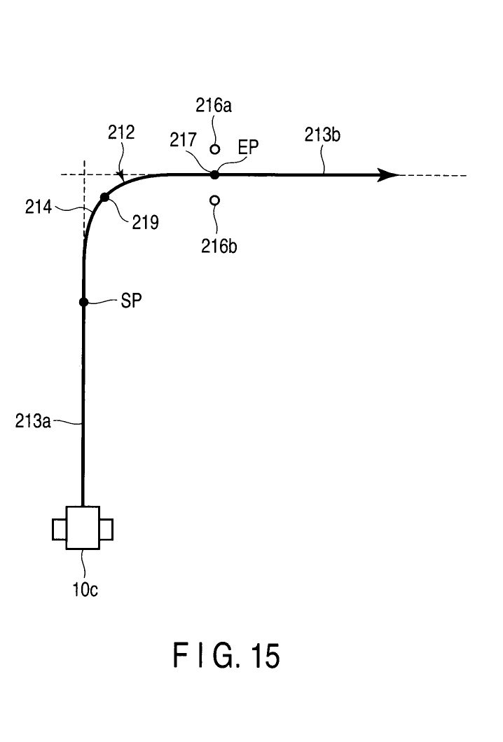

FIG. 15 is a diagram illustrating a target trajectory 212 of the movable apparatus 100. As shown in FIG. 15, the movable apparatus 100 travels along the target trajectory 212. The target trajectory 212 is formed of a combination of a first linear trajectory 213a, a second linear trajectory 213b, and a curved trajectory 214.

In the direction in which the movable apparatus 100 advances, paired objects 216a and 216b are provided across the target trajectory 212. The objects 216a and 216b are, for example, poles. The paired objects 216a and 216b are provided across a preset moving point 217. The moving point 217 is set such that the traveling movable apparatus 10 passes through the moving point 217.

The laser range finder 210 senses the distance and angle to the paired objects 216a and 216b. That is, the laser range finder 210 measures the relative position between the current position and the position of the paired objects 216a and 216b. The laser range finder 210 sets the movable apparatus 100 to be the origin of a coordinate system to calculate the coordinates of the paired objects 216a and 216b. The laser range finder 210 then outputs the coordinates to the traveling control module 81.

Based on the coordinates of the paired objects 216a and 216b, the traveling control module 81 calculates the target trajectory 212. The first linear trajectory 213a of the target trajectory 212 is a linear path designed such that the start point of the path is the current position. The curved trajectory 214 of the target trajectory 212 is a curved path designed such that the start point of the path is a first inflection point SP corresponding to the end point of the first linear trajectory 213a. The second linear trajectory 213b of the target trajectory 212 is a linear path designed such that the start point of the path is a second inflection point EP corresponding to the end point of the curved trajectory 214.

Now, a method for generating the curved trajectory 214 of the movable apparatus 10C will be described.

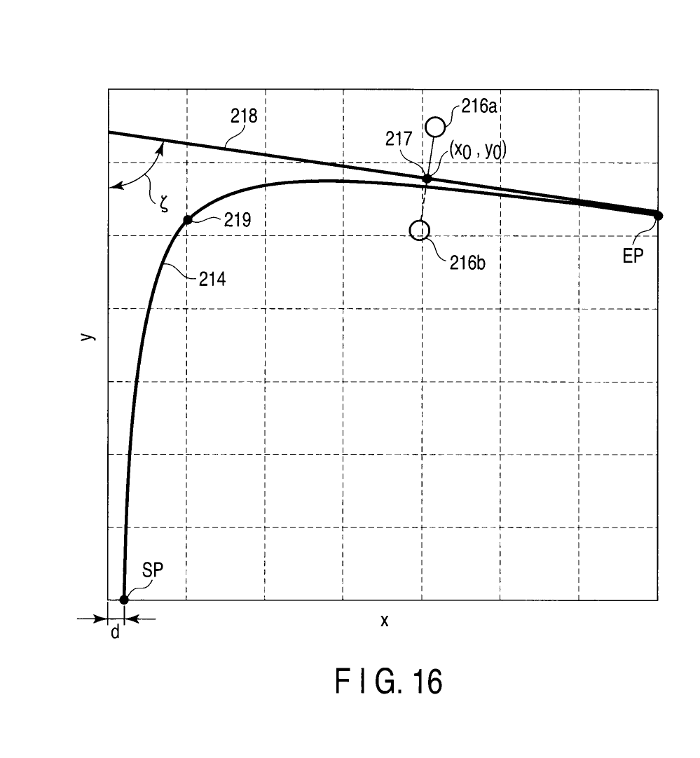

FIG. 16 is a diagram illustrating a method for generating a curved trajectory 214 for the movable apparatus 10C. The traveling control module 81 calculates the coordinates (x₀, y₀) of the moving point 217 positioned at the midpoint between the paired objects 216a and 216b. Moreover, the traveling control module 81 calculates the angle of an asymptotic line 218 extending in a direction orthogonal to a line connecting the paired objects 216a and 216b together.

The traveling control module 81 calculates the curved trajectory 214 smoothly connecting the asymptotic line 218 to a line extending in the advancing direction of the movable apparatus 10C. The curved trajectory 214 is like a hyperbolic curve with a curvature increasing gradually to a maximum curvature point 219 and decreasing gradually from the maximum curvature point 219. That is, the curved trajectory 214 is such that the minimum curvature is positioned at the first inflection point SP and at the second inflection point EP and such that the maximum curvature is positioned at the maximum curvature point 219. The curved trajectory 214 is expressed by:

$$\begin{matrix}y = \frac{{x}^{2} ( b {cos}^{2} Z - a {sin}^{2} Z ) - ab}{2 ( a + b ) x sin Z cos Z} + c & ( Expression 22 ) \\ Z = \frac{π - ζ}{2} & ( Expression 23 ) \\ a = {d}^{2} ( {cos}^{2} Z - {sin}^{2} Z {tan}^{2} Z ) + 2 cd tan Z & ( Expression 24 ) \\ b = \frac{a}{{tan}^{2} Z} & ( Expression 25 ) \\ c = {y}_{0} - \frac{{x}_{0}}{tan ( π - ζ )} & ( Expression 26 )\end{matrix}$$

In (Expression 22) to (Expression 26), (d) denotes the value of the (x) coordinate at y=0. In this case, (d) takes a value other than zero.

For example, if ξ=90° as shown in FIG. 15, the curved trajectory 214 is expressed by:

$$y = - \frac{{y}_{0} d}{x} + {y}_{0} \qquad ( Expression 27 )$$

The traveling control module 81 generates time sequence data on the curved trajectory 214 based on (Expression 22). That is, the traveling control module 81 generates time sequence data on the target rotation angles ξ_{Rr} and ξ_{Lr} of the right wheel 30a and the left wheel 30b.

On the other hand, if disturbance causes the movable apparatus 10C to deviate from the target trajectory 212, the triaxial acceleration sensor 56 senses the disturbance. When the triaxial acceleration sensor 56 senses the disturbance, the traveling control module 81 allows the laser range finder 210 to sense the distance and angle to the paired objects 216a and 216b again. The traveling control module 81 generates a curved trajectory 214 again based on the distance and angle to the paired objects 216a and 216b.

According to the moving apparatus 10C configured as described above, when the movable apparatus 10 advances from the linear trajectory 213 into the curved trajectory 214, the centrifugal acceleration increases slowly. This allows the load L from falling down from the loading surface 72 or being damaged. Moreover, the movable apparatus 10C can be prevented from deviating from the curved trajectory 214 as a result of the centrifugal force.

The curved trajectory 214 can be expressed by a single function such as (Expression 22). Thus, the curved trajectory 214 can be quickly calculated. Moreover, the centrifugal acceleration changes consecutively, allowing the first swinging mechanism 40 to more excellently follow control inputs. As a result, the movable apparatus 100 can rotate smoothly at a small turning radius.

Even if disturbance causes the movable apparatus 100 to deviate from the target trajectory 212, the traveling control module 81 generates a curved trajectory 214 again. Thus, even with disturbance, the movable apparatus 100 can reach a destination.

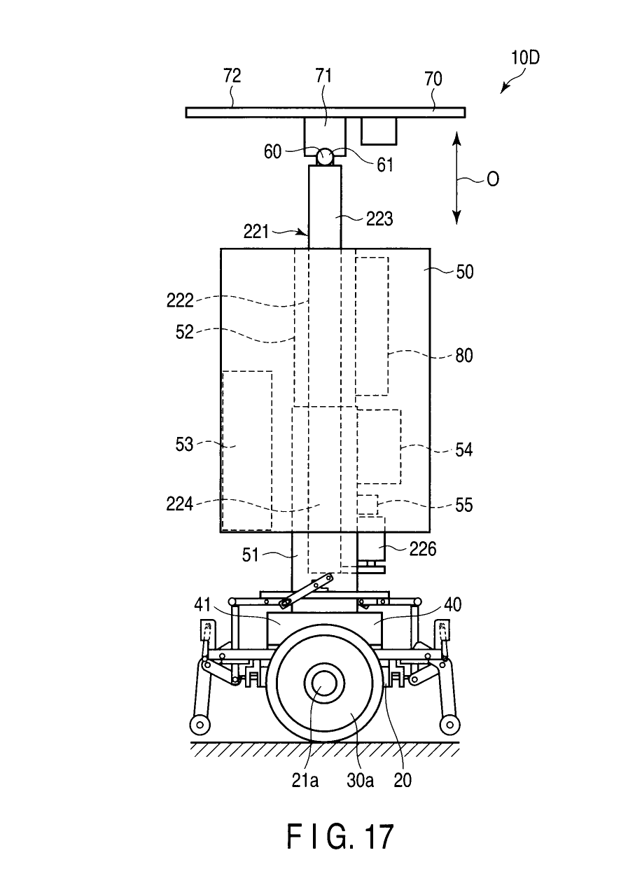

Now, a fifth embodiment of the present invention will be described. FIG. 17 is a side view showing the movable apparatus 10D according to the fifth embodiment. As shown in FIG. 17, the movable apparatus 10D comprises a table raising and lowering mechanism 221.

The table raising and lowering mechanism 221 penetrates the first intermediate shaft 51 and the second intermediate shaft 52. The table raising and lowering mechanism 221 comprises a rectilinear guide 222, a table shaft 223, and a table shaft moving section 224.

The rectilinear guide 222 is extended along the first intermediate shaft 51 and the second intermediate shaft 52 in the up-down direction. The rectilinear guide 222 guides the table shaft 223 so that the table shaft 223 moves in an axial direction shown by arrow (O) in FIG. 17.

The table shaft 223 extends along the rectilinear guide 222 and is partly accommodated in the first intermediate shaft 51 and the second intermediate shaft 52. The second swinging mechanism 60 is provided at the end of the table shaft 223. A moving external thread is formed on a part of the table shaft 223.

The table shaft moving section 224 comprises a table shaft driving motor 226. The table shaft driving motor 226 is electrically connected to the control device 80. The table shaft moving section 224 cooperates with the external thread portion provided on the table shaft 223 in forming a ball screw.

The table shaft driving motor 226 is driven under the control of the control device 80. When the table shaft driving motor 226 is driven, the table shaft moving section 224 moves the table shaft 223 in the axial direction (O) in accordance with the rotating direction of the table shaft driving motor 226.

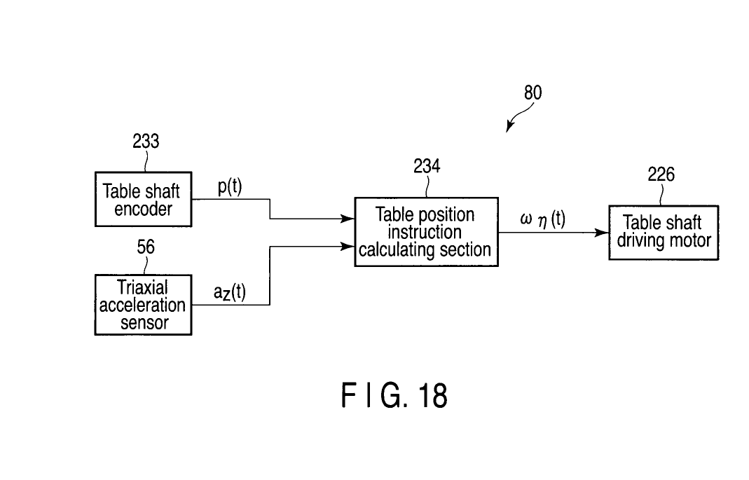

FIG. 18 is a block diagram of the table raising and lowering mechanism 221. As shown in FIG. 18, the control device 80 comprises a table shaft encoder 233 and a table position instruction calculating section 234. The table position instruction calculating section 234 is electrically connected to the table shaft encoder 233, the triaxial acceleration sensor 56, and the table shaft driving motor 226.

The table position instruction calculating section 234 obtains the position p(t) of the table shaft 223 in the axial direction (O) from a pulse from the table shaft encoder 233. Moreover, the table position instruction calculating section 234 obtains the acceleration a_{z}(t) of the movable apparatus 10D in the up-down direction, from the triaxial acceleration sensor 56.

The table position instruction calculating section 234 calculates a table target position pᵣ(t) by:

$${p}_{r} ( t ) = {\int }_{{t}_{1}}^{{t}_{2}} {\int }_{{t}_{1}}^{{t}_{2}} {a}_{z} ( t ) d {t}^{2} \qquad ( Expression 28 )$$

The table position instruction calculating section 234 determines the deviation between the target value and the current value, that is, e(t)=pᵣ(t)−p(t). The table position instruction calculating section 234 uses the deviation e(t) to calculate an instruction voltage ω_{η}(t) to be output to the table shaft driving motor 226, by means of:

$${ω}_{η} ( t ) = {K}_{C} ( e ( t ) + \frac{1}{{T}_{I}} {\int }_{0}^{t} e ( τ ) d τ + {T}_{D} \frac{d e ( t )}{d t} ) \qquad ( Expression 29 )$$

In (Expression 29), K_{C}, T_{I} and K_{D} are PID gains.

The table position instruction calculating section 234 corrects the instruction voltage ω_{η}(t) calculated as required to within a predetermined range. For example, if the instruction voltage ω_{η}(t) exceeds a voltage specified for the table shaft driving motor 226, the table position instruction calculating section 234 changes the instruction voltage ω_{η}(t) such that the instruction voltage ω_{η}(t) is equal to or lower than the specified voltage.

The table position instruction calculating section 234 outputs the instruction voltage ω_{η}(t) to the table shaft driving motor 226 to drive the table shaft driving motor 226. The table shaft driving motor 226 moves the table shaft 223 in the axial direction (O). When the table shaft moves in the axial direction (O), the second swinging mechanism 60 and the loading section 70 also move in the axial direction (O).

According to the movable apparatus 10D configured as described above, if the movable apparatus 10D vibrates in the up-down direction, the triaxial acceleration sensor 56 senses the acceleration in the up-down direction. The table position instruction calculating section 234 drives the table shaft driving motor 226 to move the loading section 70 in a direction in which the acceleration is offset. This enables a reduction in vibration applied to the load L, allowing the load L to be stably conveyed.

The method for controlling the table raising and lowering mechanism 221 is not limited to the above-described PID control. Modern control is applicable as the method.

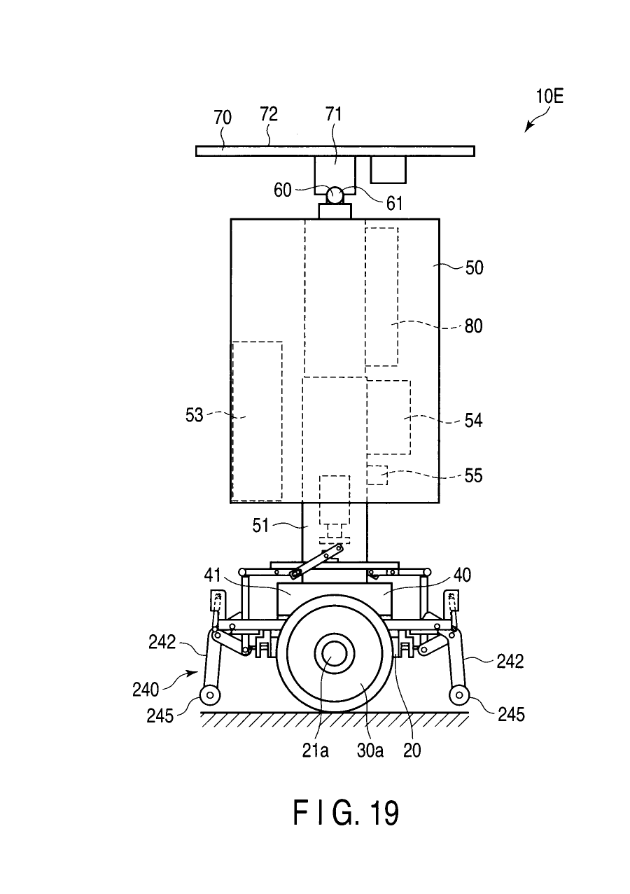

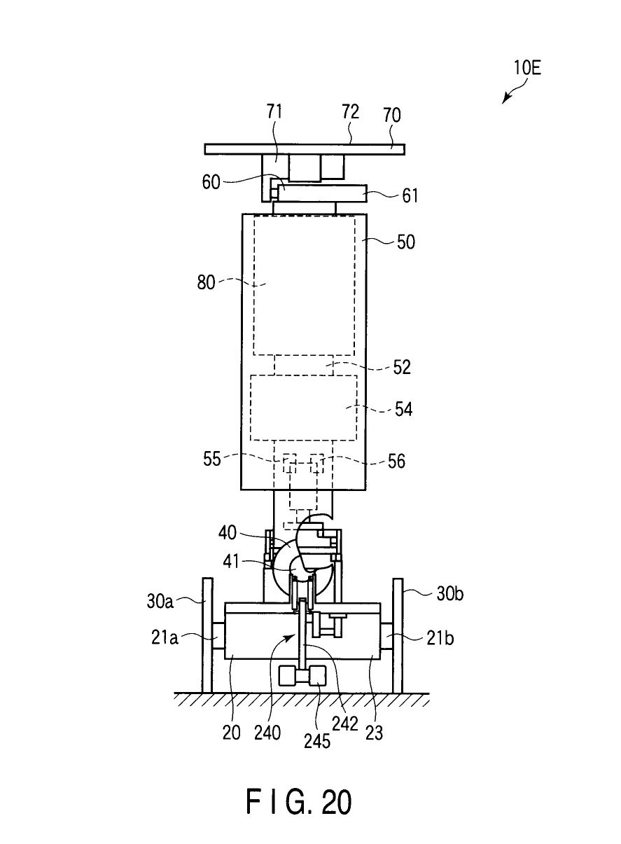

Now, a sixth embodiment of the present invention will be described. FIG. 19 is a side view showing a movable apparatus 10E according to the sixth embodiment. FIG. 20 is a front view showing the movable apparatus 10E. As shown in FIGS. 19 and 20, the movable apparatus 10E comprises a support device 240.

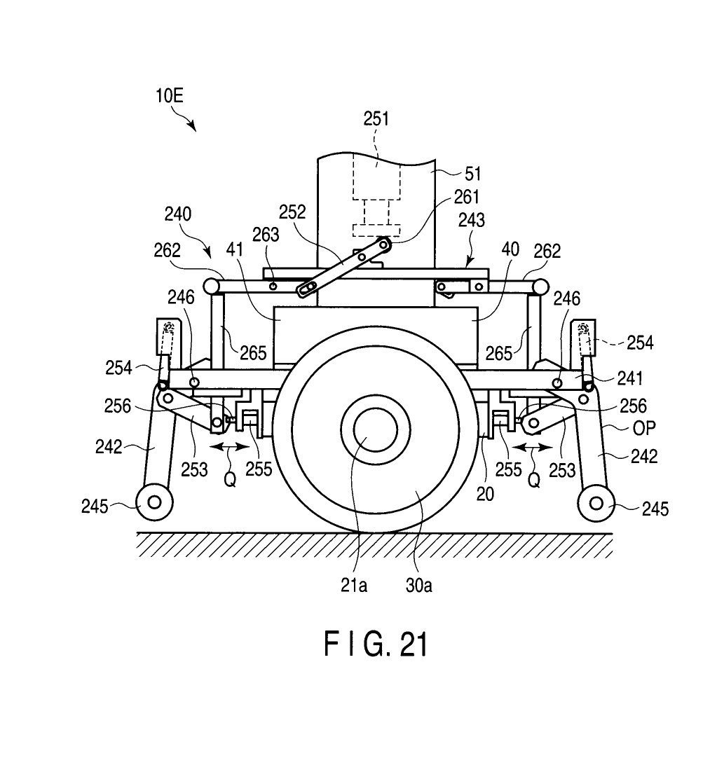

FIG. 21 is an enlarged side view showing the support device. As shown in FIG. 21, the carriage 20 comprises a frame 241. The support device 240 comprises paired support legs 242 and a support leg opening and closing mechanism 243. The frame 241 is extended in the front-back direction of the movable apparatus 10E. The paired support legs 242 are arranged in the front and rear, respectively, of the carriage 20.

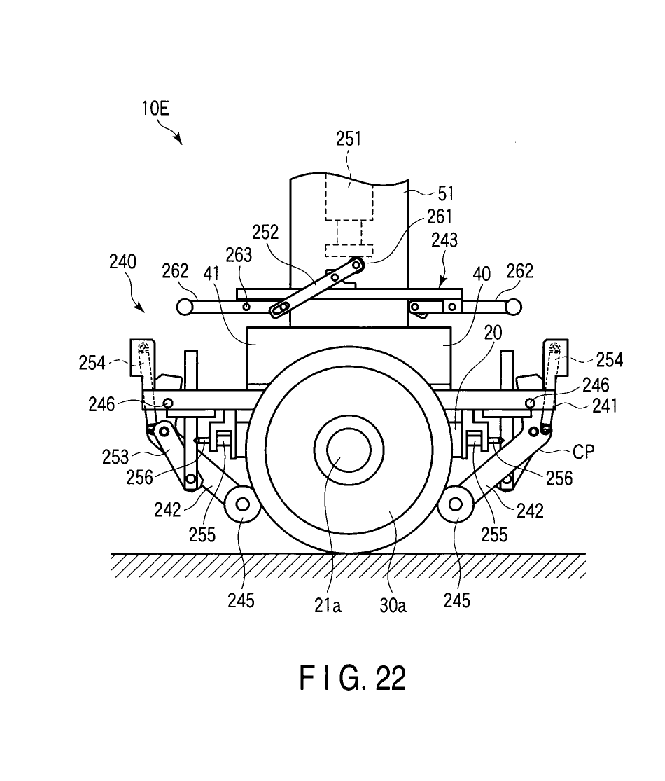

FIG. 22 is a side view showing the movable apparatus 10E with each of the paired support legs 242 closed. Each of the paired support legs 242 comprises a roller 245 provided at the end of the support leg. The paired support legs 242 are pivotally movably attached to the frame 241 by a first shaft 246. The support leg 242 is pivotally moved, by the support leg opening and closing mechanism 243, between an open position OP shown in FIG. 21 and a closed position CP shown in FIG. 22.

The support leg opening and closing mechanism 243 comprises a first actuator 251, a depression mechanism 252, paired link mechanisms 253, paired tension springs 254, paired second actuators 255, and paired holding pins 256.

The depression mechanism 252 is attached to the first intermediate shaft 51. The paired link mechanisms 253 are coupled to the paired support legs 242. For example, a solenoid actuator is applied as the second actuator 255.

The depression mechanism 252 comprises a passive portion 261 and paired abutting portions 262. The paired abutting portions 262 operate in conjunction with the passive portion 261 and moves pivotally using a second shaft 263 as a supporting point. The depression mechanism 252 is held, by a spring or the like, at a fixed position shown in FIG. 22 in a free state in which the depression mechanism 252 is subjected to no external force.

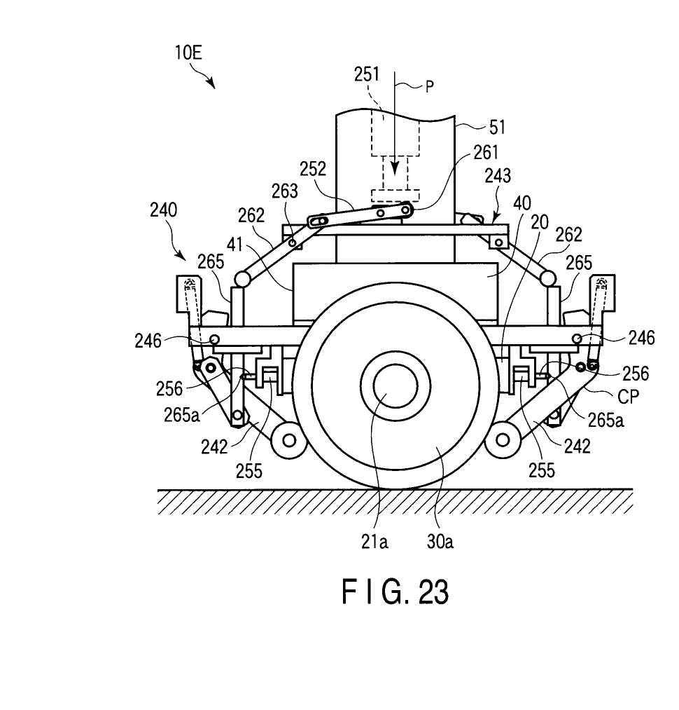

FIG. 23 is a side view showing the movable apparatus 10E in which the first actuator 251 is in operation. Each of the paired link mechanism 253 comprises a holding section 265. The holding section 265 comprises a hole 265a located opposite the holding pin 256. As shown in FIG. 23, the end of the holding section 265 receives the end of the abutting portion 262.

The first actuator 251 is electrically connected to the control device 80. The first actuator 251 is controlled by the control device 80 so as to depress the passive portion 261 of the depression mechanism 252 in a direction shown by P in FIG. 23.

While the support legs 242 are open and placed in the open position OP as shown in FIG. 21, when the passive portion 261 is depressed, the holding section 265 of each of the paired link mechanisms 253 is depressed by the corresponding abutting portion 262. As shown in FIG. 23, when the holding sections 265 are depressed, the link mechanisms 253 pivotally moves the respective support legs 242 to the closed position CP.

The tension spring 254 is provided so as to bridge the frame 241 and the support leg 242. The tension springs 254 pull the respective support legs 242 so as to maintain the corresponding support legs 242 in the open position OP.

The paired second actuator 255 moves the respective paired holding pins 256 in a pin moving direction shown by arrow Q in FIG. 21. When the support legs 242 are placed in the closed position CP as shown in FIG. 22, the holding pins 256 can be inserted into the respective holes 265a in the holding sections 265. When inserted into the holes 265a in the holding sections 265, the holding pins 256 hold the respective support legs 242 in the closed position CP.

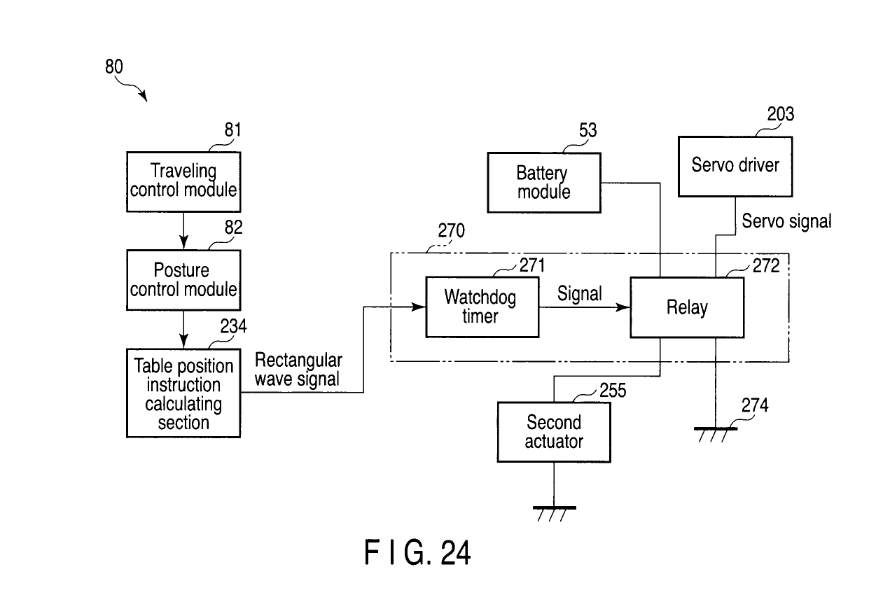

FIG. 24 is a block diagram of the support device 240. As shown in FIG. 24, the control device 80 comprises a system abnormality monitoring unit 270. The system abnormality monitoring unit 270 comprises a watchdog timer 271 and a relay 272. The relay 272 is electrically connected to the watchdog timer 271, the battery module 53, the second actuator 255, the motor driver 203, and a ground 274.

The traveling control module 81, the posture control module 82, and the table position instruction calculating section 234 are electrically connected together. While operating normally, the traveling control module 81 outputs a normal state signal to the posture control module 82, which is in a subordinate position to the traveling control module 81. While operating normally, the posture control module 82 receives the normal state signal from the traveling control module 81, which is in the superordinate position to the posture control module 82, to output the normal state signal to the table position instruction calculating section 234, which is in the subordinate position to the posture control module 82.

The table position instruction calculating section 234 connected to the lowest position receives the normal state signal from the posture control module 82, which is in the superordinate position to the table position instruction calculating section 234, to output a rectangular wave signal of a given period to the system abnormality monitoring unit 270. The component connected to the lowest position and outputting the rectangular wave signal to the system abnormality monitoring unit 270 is not limited to the table position instruction calculating section 234.

The watchdog timer 271 monitors the rectangular wave signal received from the table position instruction calculating section 234. Upon detecting an edge within a given time from the reception of the rectangular wave signal, the watchdog timer 271 outputs a signal to the relay 272.

Upon receiving a signal from the watchdog timer 271, the relay 272 turns on the circuit. When the relay 272 turns on the circuit, the second actuator 255 is supplied with power.

The second actuator 255 supplied with power inserts the holding pin 256 into the hole 265a formed in the holding section 265 as shown in FIG. 23. While being supplied with power, the second actuator 255 keeps the holding pin 256 inserted in the hole 265a in the holding section 265. When the power supply to the second actuator 255 is shut off, the holding pin 256 slips out of the hole 265a in the holding section 265.

Moreover, when the circuit is turned on, the relay 272 allows the motor driver 203 to excite the right wheel driving motor 22a. Only the motor driver 203 configured to excite the right wheel driving motor 22a has been described by way of example. However, when the relay 272 turns on the circuit, the motor drivers for all the motors used for the movable apparatus 10E excite the respective motors.

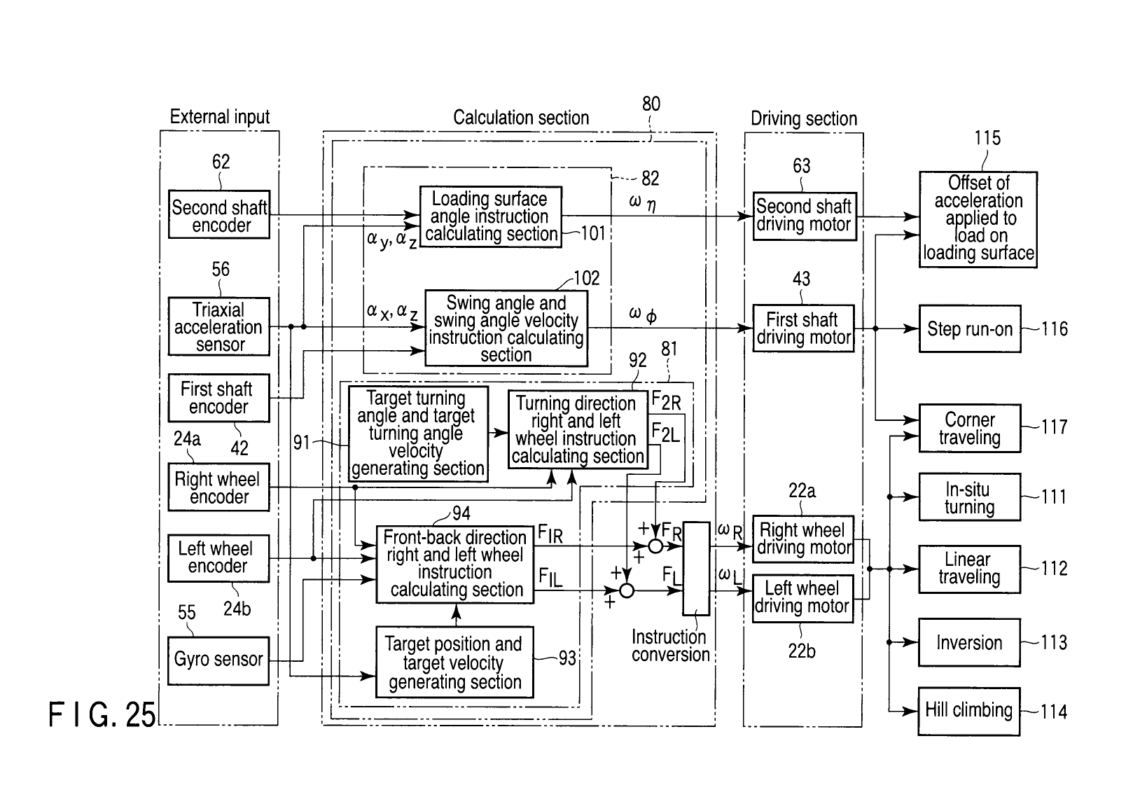

FIG. 25 is a block diagram showing a control system in the movable apparatus 10E. As shown in FIG. 25, the movable apparatus 10E according to the sixth embodiment is different from the movable apparatus 10 according to the first embodiment in that the triaxial acceleration sensor 56 is electrically connected to the posture angle target generating section 95.

The movable apparatus 10E configured as described above performs, for example, the following operation.

When the movable apparatus 10E is to be stopped, the control device 80 shuts off the power supply to the second actuator 255. When the power supply to the second actuator 255 is shut off, the holding pin 256 slips out of the hole 265a in the holding section 265.

When the holding pin 256 slips out of the hole 265a in the holding section 265, the support leg 242 held by the holding pin 256 is released. Thus, the support legs 242 are pulled and moved to the open position OP by the respective tension springs 254.

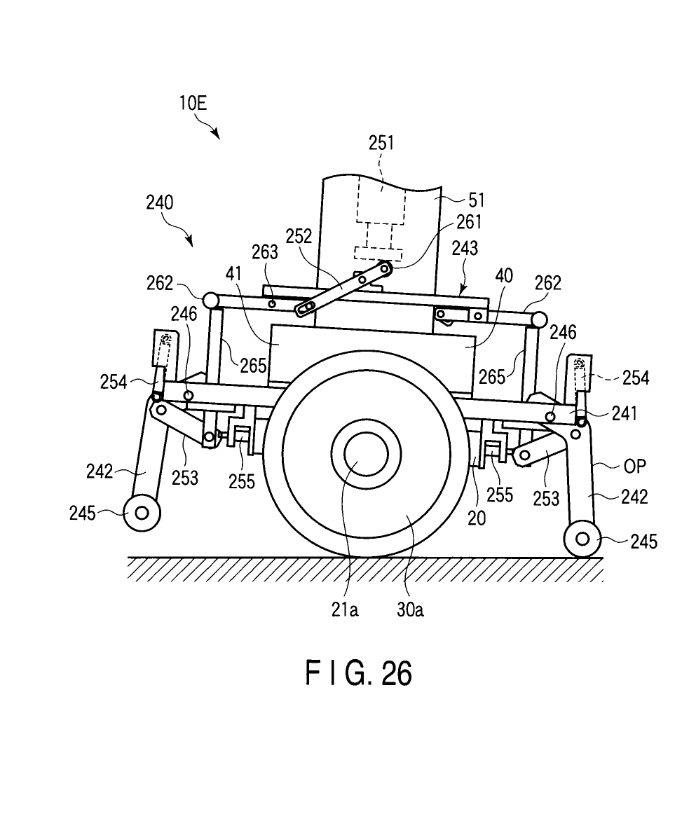

FIG. 26 is a side view showing the stopped movable apparatus 10E.

When the control device 80 terminates the inverted pendulum control, the movable apparatus 10E is tilted in the pitch direction and supported by the support legs 242 placed in the open position OP. At this time, the rollers 245 of the support legs 242 come into contact with the ground.

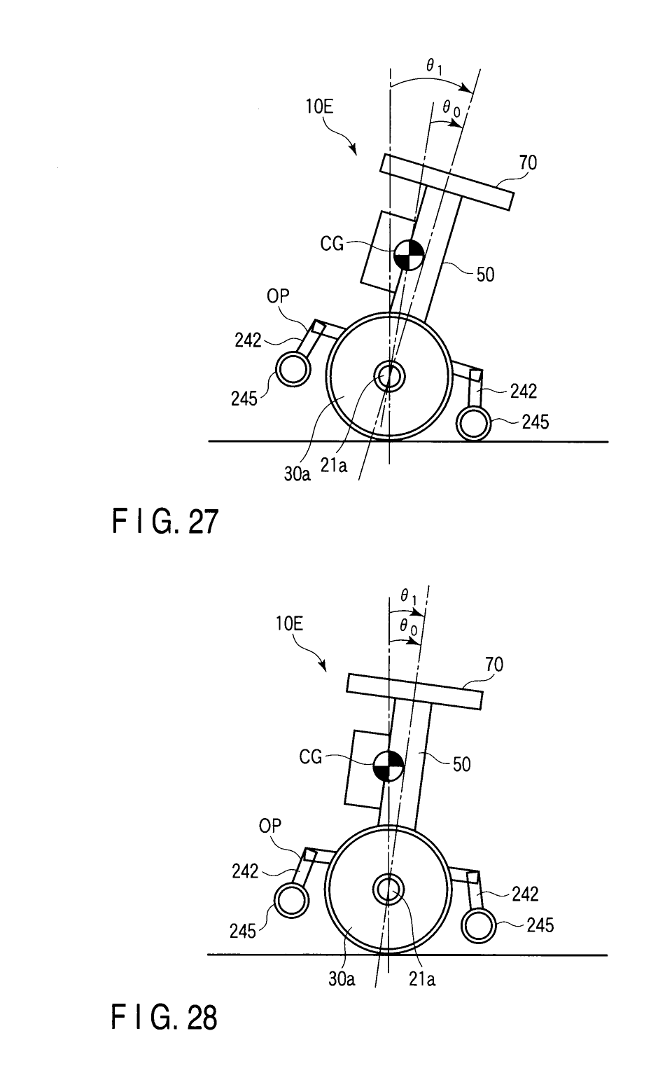

FIG. 27 is a side view schematically showing the stopped movable apparatus 10E. In the stop state shown in FIG. 27, if the movable apparatus 10E performs the inversion 113 shown in FIG. 3, the triaxial acceleration sensor 56 senses the vector of the gravitational acceleration.

Based on the vector of the gravitational acceleration sensed by the triaxial acceleration sensor 56, the control device 80 calculates the inclination θ₁ of the movable apparatus 10E in the pitch direction. When the acceleration of the movable apparatus 10E in the front-back direction is defined as aₓ and the acceleration of the movable apparatus 10E in the up-down direction is defined as a_{z}, the inclination θ₁ is expressed by:

θ₁=arctan(aₓ/a_{z}) (Expression 30)

The posture angle target generating section 95 calculates the angle target θᵣ in the pitch direction from the inclination θ₁. The angle target θᵣ is expressed by θᵣ=θ₀−θ₁. θ₀ denotes the inclination of the center of gravity CG of the movable apparatus 10E obtained when the movable apparatus 10E is located in the vertical direction in a self-standing manner. θ₀ is a designed or measured value. θ₀ is prerecorded in the posture angle target generating section 95.

The posture angle target generating section 95 inputs the angle target θᵣ to the front-back instruction calculating section 94. Based on the input angle target θr, the front-back instruction calculating section 94 calculates the right wheel propulsion F_{1R} and the left wheel propulsion F_{1L} as shown in (Expression 5). The front-back instruction calculating section 94 then outputs the calculated right wheel propulsion F_{1R} and left wheel propulsion Fn.

FIG. 28 is a side view schematically showing the inverted movable apparatus 10E. As shown in FIG. 28, when the movable apparatus 10E is inverted, θ₀ is equal to θ₁.

When the movable apparatus 10E is stably inverted, the control device 80 allows the first actuator 251 to be driven. The first actuator 251 depresses the passive portion 261 of the depression mechanism 252. Thus, the support legs 242 move pivotally from the open position OP to the closed position CP. When the support legs 242 move pivotally to the closed position CP, each holding pin 256 is inserted into the hole 265a in the corresponding holding section 265 by the corresponding second actuator 255, to hold the support legs 242 in the closed position CP.

The above-described control allows the stopped movable apparatus 10E to perform the inversion 113. After the stopped movable apparatus 10E performs the inversion 113, the movable apparatus 10E performs the same inverted pendulum control as that in the first embodiment.

If the control device 80 becomes abnormal, the rectangular wave signal output to the system abnormality monitoring unit 270 by the table position instruction calculating section 234 is stopped in an on or off state. When the rectangular wave signal from the table position instruction calculating section 234 is stopped, the signal output to the relay 272 by the watchdog timer 271 is also interrupted.

When the signal from the watchdog timer 271 is interrupted, the relay 272 determines that abnormality occurs to turn off the circuit. When the circuit is turned off, the power supply to the second actuator 255 is shut off. Thus, the holding pin 256 slips out of the hole 265a in the holding section 265. Moreover, the motor driver 203 turns off the excitation of the right wheel driving motor 22a. The plural other motor drivers turn off the excitation of the respective motors.

When the holding pin 256 slips out of the hole 265a in the holding section 265, the support leg 242 held by the holding pin 256 is released. Thus, the support legs 242 are pulled and moved to the open position OP by the respective tension springs 254.

The above-described control allows the support legs 242 to move to the open position OP if the control device 80 becomes abnormal. As shown in FIG. 25, even if the movable apparatus 10E is stopped by the abnormality of the control device 80, the support legs 242 support the movable apparatus 10E.

The method for sensing the abnormality is not limited to the above-described one. For example, the control device 80 may sense the abnormality if the gyro sensor 55 senses that the movable apparatus 10E has tilted by an amount larger than that by which the movable apparatus 10E tilts during normal inversion. In this case, the relay 272 receives an abnormality sense signal to turn off the circuit.

Moreover, if the electricity stored in the battery module 53 is exhausted, the power supply to the second actuator 255 is interrupted. Thus, the holding pin 256 slips out of the hole 265a in the holding section 265 to move the support legs 242 to the open position OP.

According to the movable apparatus 10E, if the movable apparatus 10E stops, the support legs 242 support the movable apparatus 10E. Thus, the movable apparatus 10E can be prevented from turning over, eliminating the need for personnel who support the stopped movable apparatus 10E.

If the control device 80 becomes abnormal, the support legs 242 move to the open position OP. Thus, even if the control device 80 becomes defective, the movable apparatus 10E can be prevented from turning over. Moreover, if the electricity stored in the battery module 53 is exhausted, the support legs 242 also move to the open position OP. Hence, even if the electricity stored in the battery module 53 is exhausted, the movable apparatus 10E can be prevented from turning over.

If the control device 80 becomes abnormal, the motor driver 203 and the plural other motor drivers turn off the excitation of the right wheel driving motor 22a and the other motors. Thus, the motors in the movable apparatus 10E can be prevented from being driven by an abnormal instruction.

When the movable apparatus 10E is supported by the support legs 242, the rollers 245 come into contact with the ground. Hence, even if the movable apparatus 10E stops during traveling, the movable apparatus 10E can be prevented from being turned over by inertia.

If the stopped movable apparatus 10E performs the inversion 113, the angle target θᵣ is calculated from the inclination θ₁ obtained by the triaxial acceleration sensor 56. This enables a reduction in the amount of time from the start of the inversion 113 until the movable apparatus 10E is stabilized. Moreover, the stopped movable apparatus 10E can perform the inversion 113 regardless of the magnitude of the inclination θ₁.

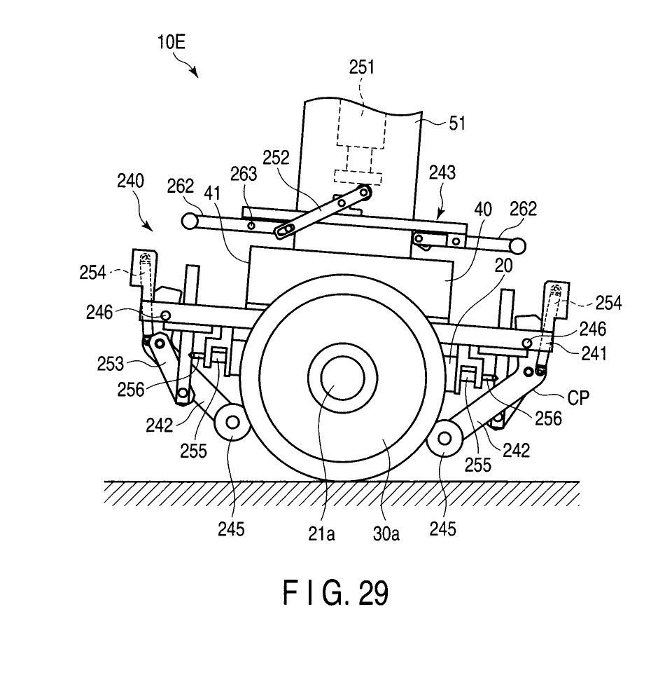

FIG. 29 is a side view showing the traveling movable apparatus 10E. When the movable apparatus 10E is stably inverted, the support legs 242 are held in the closed position CP. Thus, even when the movable apparatus 10E tilts during traveling, the support legs 242 can be prevented from interfering with the ground.

In the above-described sixth embodiment, the first actuator 251 depresses the passive portion 261 of the link mechanism 253. However, the present invention is not limited to this configuration. For example, the table shaft 223 in the fifth embodiment may depress the passive portion 261 of the link mechanism 253.

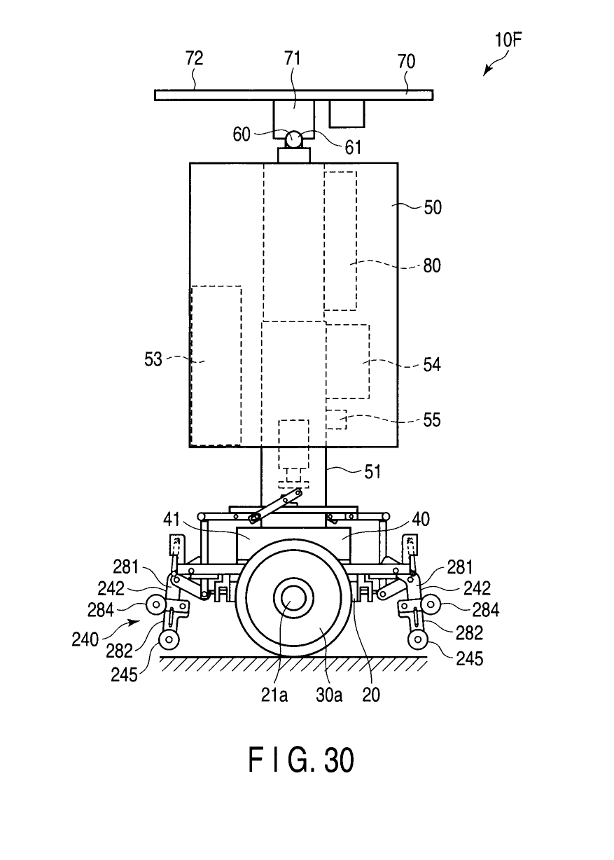

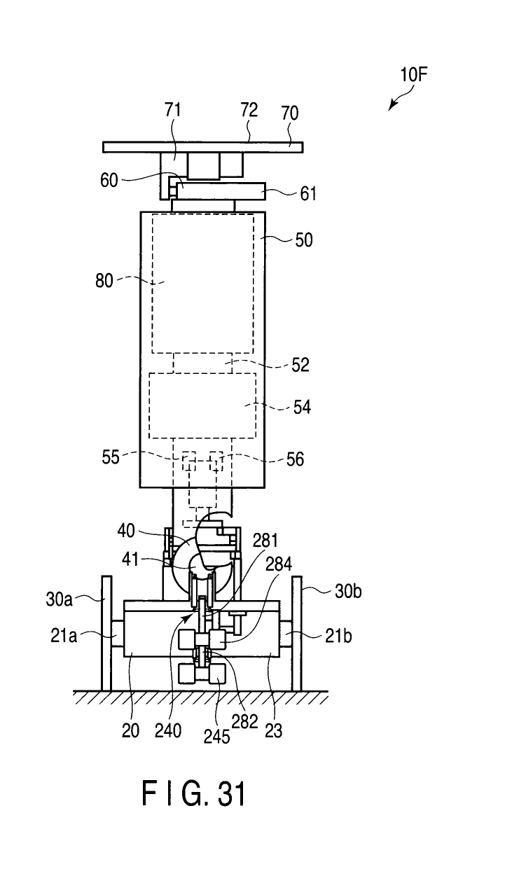

Now, a seventh embodiment of the present invention will be described. FIG. 30 is a side view showing a movable apparatus 10F according to the seventh embodiment. FIG. 31 is a front view showing the movable apparatus 10F. In the seventh embodiment, the paired support legs 242 are formed by paired first leg portions 281 and paired second leg portions 282.

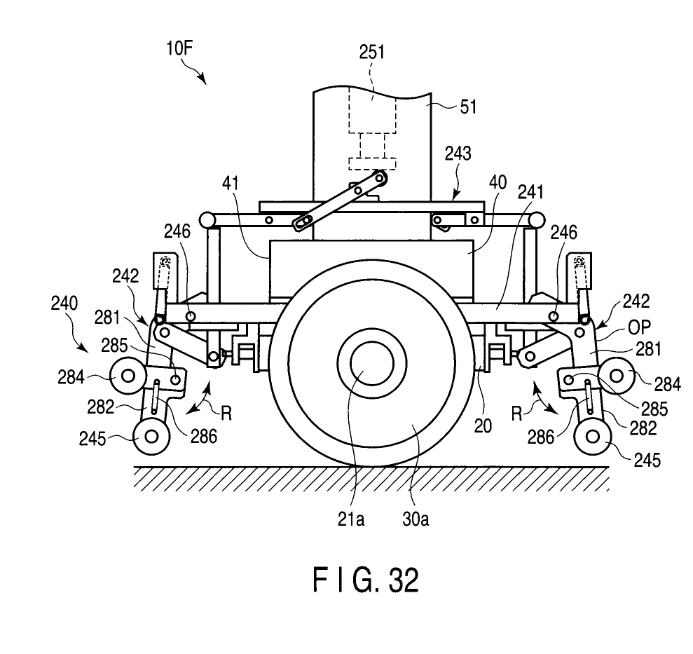

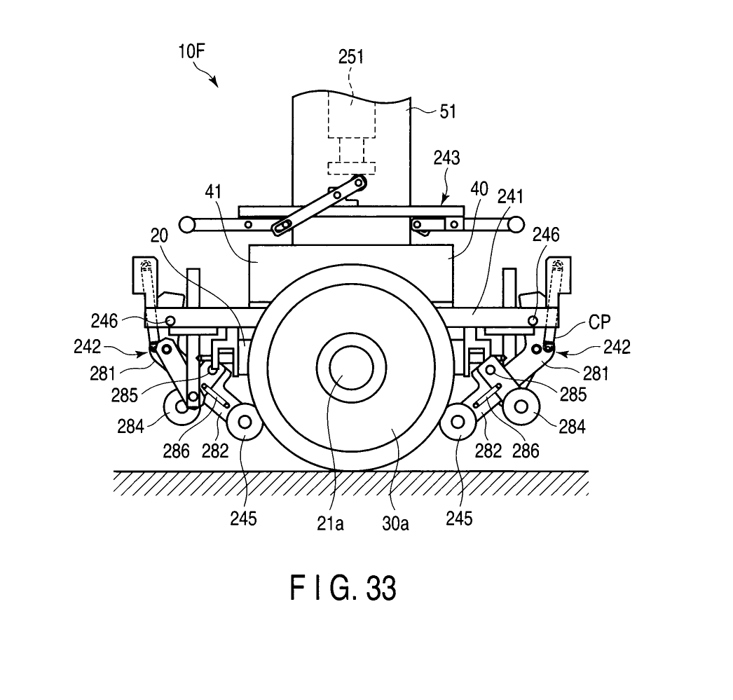

FIG. 32 is an enlarged side view of the support device 240. FIG. 33 is a side view showing the movable apparatus 10F in which the paired first legs 281 are closed. As shown in FIG. 32, the base end of each of the paired first legs 281 is pivotally movably attached to the frame 241 of the carriage 20 via the first shaft 246. Each of the paired first leg portions 281 comprises an auxiliary roller 284. The auxiliary roller 284 is located so as to project forward or backward from the movable apparatus 10F.

Each of the paired second leg portions 282 is attached to the leading end of the corresponding first leg portion 281 via a third shaft 285. Each of the paired second leg portions 282 comprises a roller 245 attached to the end and an auxiliary spring 286. Each of the second leg portions 282 can move pivotally using the third shaft 285 as a supporting point in a direction shown by arrow R in FIG. 32.

The auxiliary spring 286 is provided so as to bridge the second leg portion 282 and the first leg portion 281. The auxiliary spring 286 pulls the second leg portion 282 so as to maintain the second leg portion 282 in a given position shown in FIG. 32.

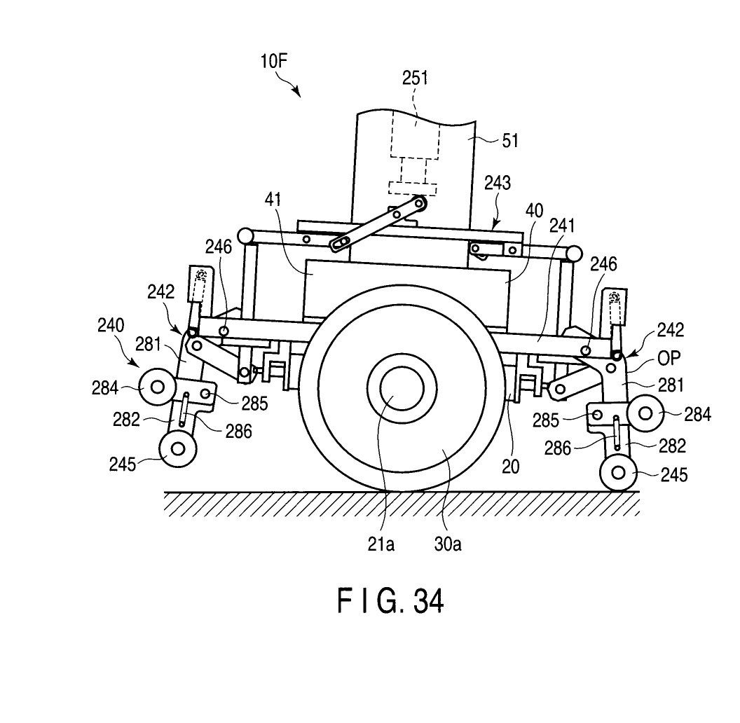

FIG. 34 is a side view showing the stopped movable apparatus 10F. When the movable apparatus 10F stops, the control device 80 terminates the inverted pendulum control. Thus, the movable apparatus 10F is tilted in the pitch direction and supported by the support legs 242 placed in the open position OP. At this time, the rollers 245 of the second leg portions 282 come into contact with the ground.

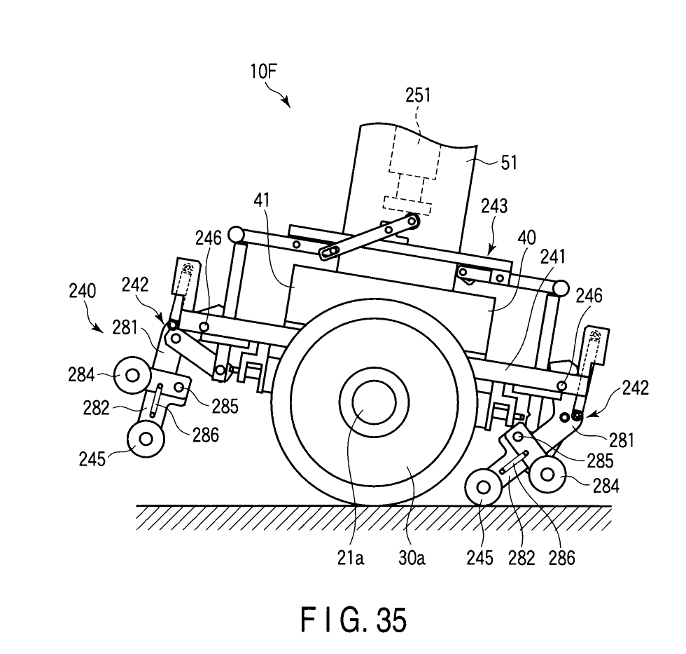

FIG. 35 is a side view showing the traveling movable apparatus 10F in which the first leg portions 281 are open. If the control device 80 becomes abnormal, the support legs 242 held by the holding pins 256 are released. However, as shown in FIG. 35, the movable apparatus 10F is tilted in the advancing direction by inertia during traveling. Thus, before the support legs 242 move to the open position OP, the rollers 245 have interfered with the ground.

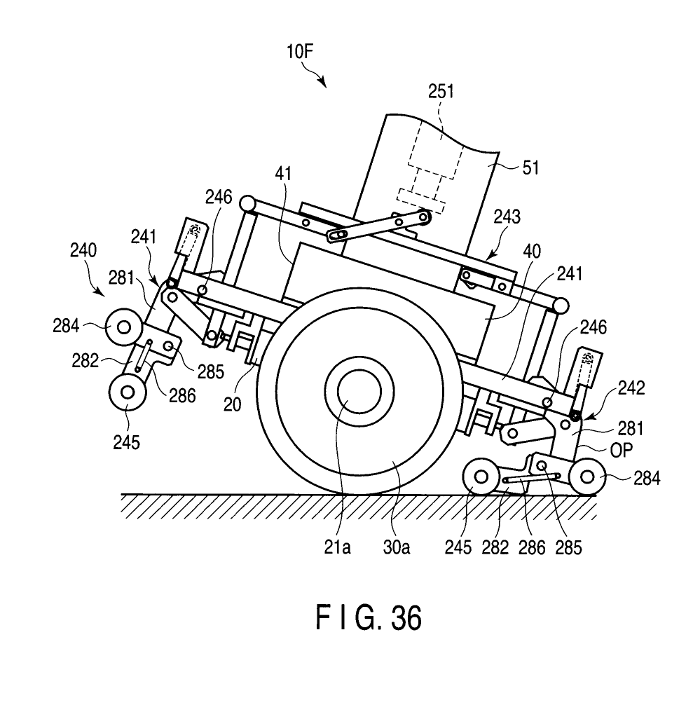

FIG. 36 is a side view showing the emergency-stopped movable apparatus 10F. When the rollers 245 interfere with the ground before the support legs 242 have moved to the open position OP, the second leg portions 282 press the ground and move pivotally in the R direction using the respective third shafts 285 as supporting points.

The pivotal movement of the second leg portions 282 allows the respective first leg portions 281 to move to the open position OP. When the movable apparatus 10F further tilts in the advancing direction, the auxiliary rollers 284 of the first leg portions 281 comes into contact with the ground. As shown in FIG. 36, the first leg portions 281 are placed in the open position OP to support the movable apparatus 10F.

According to the movable apparatus 10F configured as described above, even if for example, the control device 80 becomes defective during traveling, the first leg portions 281 move to the open position. Thus, even in case of emergency during traveling, the movable apparatus 10F can be prevented from turning over.

The abnormality of the control device 80 is not only the case in which the first leg portions 281 move to the open position. For example, as is the case with the sixth embodiment, even if the electricity stored in the battery module 53 is exhausted, the movable apparatus 10F can be prevented turning over.

When the movable apparatus 10F is supported by the first leg portions 281, the auxiliary rollers 284 come into contact with the ground. Thus, even if the movable apparatus 10F stops during traveling, the movable apparatus 10F can be prevented from being turned over by inertia.

The present invention is not limited to the as-described embodiments. In practice, the components of the embodiments can be varied without departing from the spirits of the present invention. Furthermore, various inventions can be formed by appropriately combining a plurality of the components disclosed in the above-described embodiments. For example, some of the components shown in the embodiments may be omitted. Moreover, components of different embodiments may be appropriately combined together.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A movable apparatus comprising:
a carriage;
coaxial paired wheels configured to support the carriage;
a wheel actuator configured to rotationally drive the paired wheels by inverted pendulum control;
a loading section provided above the carriage;
a swinging section interposed between the carriage and the loading section and comprising a first swinging mechanism configured to swing the loading section around a first shaft extending in a direction crossing an axle of the wheels and a second swinging mechanism configured to swing the loading section around a second shaft provided parallel to the axle;
acceleration sensing device configured to measure accelerations applied to the loading section in three mutually orthogonal directions; and
a swing angle control device configured to control the swing angle of each of the first swinging mechanism and the second swinging mechanism based on the accelerations obtained by the acceleration sensing device, to swing the loading section in a direction in which a component force of the acceleration applied to the loading section in a horizontal direction and a component force of gravity are balanced.

2. The movable apparatus of claim 1, wherein;
the first swinging mechanism is positioned below a center of gravity of the movable apparatus.

3. The movable apparatus of claim 2, wherein;
the swinging section comprises a body portion,
the first swinging mechanism is provided between the carriage and the body portion, and
the second swinging mechanism is provided between the body portion and the loading section.

4. The movable apparatus of claim 3, wherein;
the center of gravity of the movable apparatus is positioned in the body portion.

5. A movable apparatus comprising:
a carriage;
coaxial paired wheels configured to support the carriage;
a wheel actuator configured to rotationally drive the paired wheels by inverted pendulum control;
a loading section provided above the carriage; and
acceleration sensing device configured to measure accelerations applied to the loading section in three mutually orthogonal directions, wherein;
based on the accelerations obtained by the acceleration sensing device, the loading section is swung in a direction in which a component force of the acceleration applied to the loading section in a horizontal direction and a component force of gravity are balanced.

6. The movable apparatus of claim 1, further comprising;
a wheel rotation angle sensing device configured to sense the rotation angle of the paired, wherein;
based on the velocity of the paired wheels calculated by the wheel rotation angle sensing section, the swing angle control device calculates the acceleration in an axle direction to allow the swinging section to swing the loading section in the direction in which the component force of the acceleration applied to the loading section in the horizontal direction and the component force of gravity are balanced.

7. The movable apparatus of claim 1, further comprising;
a control device comprising the swing angle control device;
an external sensor configured to measure a relative position between a current position and the position of each of paired objects provided across a preset moving point; and
a moving path calculating section configured to calculate a target path based on the relative position measured by the external sensor, the target path being formed of a combination of a first linear trajectory with a start point corresponding to the current position, a curved trajectory with a start point corresponding to an end point of the first linear, the curved trajectory having a minimum curvature at the start point, a maximum curvature at a midpoint, and the minimum curvature at an end point, and a second linear trajectory with a start point corresponding to the end point of the curved trajectory.

8. The movable apparatus of claim 3, further comprising;
a table raising and lowering mechanism comprising a table shaft comprising the second swinging mechanism at an end of the shaft, a table shaft moving section configured to move the table shaft in an axial direction, and a table shaft encoder configured to measure the position of the table shaft in the axial direction; and
a control device comprising the swing angle control device and configured to control the table raising and lowering mechanism, wherein;
the control device feeds back a difference between the position of the table shaft obtained by the table shaft encoder and a target position calculated by integrating the acceleration in a vertical direction obtained by the acceleration sensing device, to allow the table shaft moving section to move the table shaft.

9. The movable apparatus of claim 3, further comprising;
paired support legs arranged in a front and a rear, respectively, of the carriage and which is pivotally movable between an open position where the body portion is supported and a closed position where interference with ground is avoided; and
a support leg opening and closing mechanism configured to pivotally move the paired support legs between the open position and the closed position.

10. The movable apparatus of claim 1, further comprising;
a control device comprising the swing angle control device and a gyro sensor configured to sense the angular velocity of the body portion; and
a wheel rotation angle sensing device configured to sense the rotation angle of the paired; wherein;
the control device calculates a speed instruction for a translational direction based on a sum of a first calculation value obtained by multiplying a pre-calculated first gain by a difference between a preset position target and the current position calculated based on the rotation angle sensed by the wheel rotation angle sensing device, a second calculation value obtained by multiplying a pre-calculated third gain by a difference between a preset velocity target multiplied by a pre-calculated second gain and the velocity calculated by rotation angle sensed by the wheel rotation angle sensing device, a third calculation value obtained by multiplying a pre-calculated fourth gain by a difference between a preset angle target and the body inclination calculated by angular velocity sensed by the gyro sensor, and a fourth calculation value obtained by multiplying a pre-calculated fifth gain by a difference between a preset angular velocity target and the angular velocity sensed by the gyro sensor.
